(19) United States
(12) Patent Application Publication
(10) Pub. No.: US 2026/0279760 A1
(43) Pub. Date: Sep. 17, 2026

(54) NEGATIVE ELECTRODE FOR RECHARGEABLE LITHIUM BATTERY, METHOD FOR MANUFACTURING THE SAME, AND RECHARGEABLE LITHIUM BATTERY INCLUDING THE SAME

(71) Applicant: SAMSUNG SDI CO., LTD., Yongin-si (KR)

(72) Inventors: Minji KIM, Yongin-si (KR); Injoe JUNG, Yongin-si (KR)

(73) Assignee: SAMSUNG SDI CO., LTD., Yongin-si (KR)

(21) Appl. No.: 19/545,763

(22) Filed: Feb. 20, 2026

(30) Foreign Application Priority Data
Mar. 12, 2025 (KR) 10-2025-0032287
Apr. 1, 2025 (KR) 10-2025-0042299

(51) Int. Cl. H01M 4/04; H01M 4/02; H01M 4/36; H01M 4/62; H01M 10/0525; H01M 10/0587

(52) U.S. Cl. CPC H01M 4/044; H01M 4/0404; H01M 4/364; H01M 4/621; H01M 10/0525; H01M 10/0587; H01M 2004/021; H01M 2004/027

(57) ABSTRACT

The present disclosure relates to a negative electrode for a rechargeable lithium battery, a method for manufacturing the negative electrode, and a rechargeable lithium battery including the negative electrode. The negative electrode includes a negative electrode current collector, and a negative electrode active material layer on the negative electrode current collector. The negative electrode active material layer has a long axis extending in a first direction. The negative electrode active material layer includes a first region and a second region arranged along the first direction. A ratio of a mixture density of the first region to the mixture density of the second region is greater than or equal to about 85% and less than about 100%.

### CROSS-REFERENCE TO RELATED APPLICATION

This U.S. nonprovisional application claims priority under 35 U.S.C § 119 to Korean Patent Application No. 10-2025-0032287 filed on Mar. 12, 2025, and to Korean Patent Application No. 10-2025-0042299 filed on Apr. 1, 2025 in the Korean Intellectual Property Office, the disclosures of each of which are hereby incorporated by reference in their entirety.

### BACKGROUND

The present disclosure relates to a negative electrode for a rechargeable lithium battery, a method for manufacturing the negative electrode, and a rechargeable lithium battery including the negative electrode.

With increasing presence of battery-powered electronic devices such as, e.g., mobile phones, notebook computers, electric vehicles, and the like, the demand for rechargeable batteries with high energy density and large capacity is increasing. Accordingly, extensive enhancing the performance of rechargeable lithium batteries may be advantageous.

A rechargeable lithium battery generally includes a positive electrode, a negative electrode, and an electrolyte. Both the positive and negative electrodes contain active materials capable of lithium-ion intercalation and deintercalation. Electrical energy is generated through oxidation and reduction reactions as lithium ions move between the electrodes during charging and discharging.

### SUMMARY

An example embodiment of the present disclosure includes a negative electrode for a rechargeable lithium battery capable of improving electrolyte impregnation characteristics at a winding center portion or a central portion of a negative electrode, thereby reducing or preventing lithium deposition.

An example embodiment of the present disclosure includes a rechargeable lithium battery having a high capacity and improved cycle-life characteristics.

An example embodiment of the present disclosure includes a method for manufacturing a negative electrode having improved cycle-life characteristics by selectively reducing a mixture density at a winding center portion or a central portion of the negative electrode.

According to an example embodiment of the present disclosure, a negative electrode for a jelly-roll electrode may include a negative electrode current collector, and a negative electrode active material layer on the negative electrode current collector. The negative electrode active material layer may have a long axis extending in a first direction. The negative electrode active material layer may include a first region and a second region arranged, e.g., sequentially arranged, along the first direction. A ratio of a mixture density of the first region to the mixture density of the second region may be greater than or equal to about 85% and less than about 100%.

According to an example embodiment of the present disclosure, a negative electrode for a rechargeable lithium battery may include a negative electrode current collector, and a negative electrode active material layer on the negative electrode current collector. The negative electrode active material layer may have a short axis extending in a first direction. The negative electrode active material layer may include first regions facing each other in the first direction, and a second region between the first regions. A ratio of a mixture density of the second region to the mixture density of the first region may be greater than or equal to about 85% and less than about 100%.

According to an example embodiment of the present disclosure, a method for manufacturing a negative electrode for a jelly-roll electrode may include preparing a negative electrode current collector, forming a negative electrode active material layer on the negative electrode current collector, the negative electrode active material layer having a long axis extending in a first direction, and the negative electrode active material layer including a first region and a second region arranged, e.g., sequentially arranged, along the first direction, and selectively performing a surface treatment process on the first region excluding the second region to remove a binder in a surface portion of the first region. A mixture density of the first region may be less than the mixture density of the second region.

According to an example embodiment of the present disclosure, a method for manufacturing a negative electrode for a rechargeable lithium battery may include preparing a negative electrode current collector, forming a negative electrode active material layer on the negative electrode current collector, the negative electrode active material layer having a short axis extending in a first direction, and including first regions opposing each other in the first direction and a second region between the first regions, and selectively performing a surface treatment process on the second region excluding the first regions to remove a binder in a surface portion of the second region. A mixture density of the second region may be less than a mixture density of the first region.

### BRIEF DESCRIPTION OF DRAWINGS

FIG. 1 is a schematic conceptual diagram of a rechargeable lithium battery according to example embodiments of the present disclosure.

FIG. 2 is a schematic diagram illustrating a rechargeable lithium battery according to an example embodiment of the present disclosure.

FIG. 3 is a plan view of a rechargeable lithium battery according to an example embodiment of the present disclosure.

FIG. 4 is a schematic diagram illustrating an electrode assembly according to an example embodiment of the present disclosure.

Each of FIG. 5 to FIG. 7 is a schematic diagram illustrating a rechargeable lithium battery according to an example embodiment of the present disclosure.

FIG. 8 is a cross-sectional view of a negative electrode for a jelly-roll electrode according to an example embodiment of the present disclosure.

FIG. 9 is a plan view of a negative electrode for a jelly-roll electrode according to an example embodiment of the present disclosure.

FIG. 10A is a cross-sectional view taken along line X-X′ of FIG. 9.

FIG. 10B is a cross-sectional view taken along line Y-Y′ of FIG. 9.

FIG. 11 is a diagram describing a method for manufacturing a negative electrode for a jelly-roll electrode according to an example embodiment of the present disclosure.

FIG. 12 is a plan view of a negative electrode for a rechargeable lithium battery according to another example embodiment of the present disclosure.

FIG. 13A is a cross-sectional view taken along line X-X′ of FIG. 12.

FIG. 13B is a cross-sectional view taken along line Y-Y′ of FIG. 12.

FIG. 14 is a diagram describing a method for manufacturing a negative electrode for a rechargeable lithium battery according to another example embodiment of the present disclosure.

FIG. 15 is a flowchart illustrating a method of manufacturing a negative electrode, according to an example embodiment.

### DETAILED DESCRIPTION

To fully understand the configuration and effects of the present disclosure, some example embodiments are described with reference to the accompanying drawings. However, the present disclosure is not limited to the following example embodiments and may be implemented in various forms. The example embodiments are provided solely to illustrate the present disclosure and to enable those skilled in the art to fully understand its scope.

In this description, when an element is described as being “on” another element, the element may be directly on the other element, or one or more intervening elements may be present therebetween. In the drawings, certain thicknesses may be exaggerated to better illustrate technical details. Throughout the specification, like reference numerals indicate like elements.

In this description, even when the same terms or reference numerals are used among different example embodiments, the structures, functions, or definitions indicated by such terms or reference numerals may differ. Accordingly, the use of the same terms or reference numerals does not necessarily indicate the same elements, and such terms or numerals may be interpreted differently according to example embodiments.

Unless otherwise explicitly stated in this description, singular forms may also include plural forms. In addition, unless explicitly stated otherwise, the phrase “A or B” may indicate “A but not B,” “B but not A,” and “A and B.” The terms “comprises/includes” and “comprising/including” do not exclude the presence or addition of one or more other components.

In this description, the phrase “combination thereof” may refer to a mixture, a stack, a composite, a copolymer, an alloy, a blend, or a reaction product.

Unless otherwise specifically defined, the term “particle diameter” refers to an average particle diameter. The particle diameter may represent the median particle size (D50), which corresponds to the diameter of particles at 50 vol % in a cumulative particle size distribution. The average particle diameter (D50) can be measured using widely known methods, such as a particle size analyzer, transmission electron microscope (TEM) imaging, or scanning electron microscope (SEM) imaging. Alternatively, dynamic light scattering may be used, where particle counts within size ranges are analyzed to calculate the average particle diameter (D50). Additionally, a laser scattering method may be employed, in which a target particle is dispersed in a solvent, introduced into a laser scattering particle measurement device (e.g., MT3000 from Microtrac, Inc.), irradiated with ultrasonic waves at 28 kHz and 60 W, and subsequently analyzed to determine the D50 value based on a 50% cumulative particle size distribution.

When the terms “about” or “substantially” are used in this specification in connection with a numerical value, it is intended that the associated numerical value include a tolerance of ±10% around the stated numerical value. When ranges are specified, the range includes all values therebetween such as increments of 0.1%.

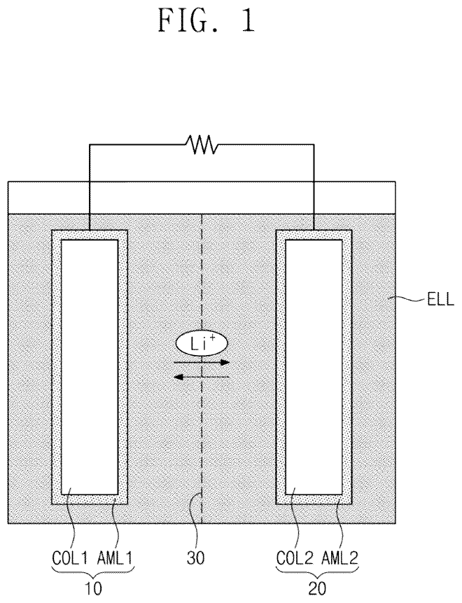

FIG. 1 is a simplified conceptual diagram illustrating a rechargeable lithium battery according to example embodiments of the present disclosure. Referring to FIG. 1, the rechargeable lithium battery may include a positive electrode 10, a negative electrode 20, a separator 30, and an electrolyte ELL.

The positive electrode 10 and the negative electrode 20 may be spaced apart from each other across the separator 30. The separator 30 may be disposed between the positive electrode 10 and the negative electrode 20. The positive electrode 10, the negative electrode 20, and the separator 30 may be in contact with the electrolyte ELL. The positive electrode 10, the negative electrode 20, and the separator 30 may be impregnated in the electrolyte ELL.

The electrolyte ELL may be or include a medium by which lithium ions are transferred between the positive electrode 10 and the negative electrode 20. In the electrolyte ELL, the lithium ions may move through the separator 30 toward one of the positive electrode 10 and the negative electrode 20.

### Positive Electrode 10

The positive electrode 10 for a rechargeable lithium battery may include a current collector COL1, and a positive electrode active material layer AML1 formed on the current collector COL1. The positive electrode active material layer AML1 may include a positive electrode active material, and further include a binder and/or a conductive material.

For example, the positive electrode 10 may further include an additive that can constitute a sacrificial positive electrode.

An amount of the positive electrode active material may be in a range of about 90 wt % to about 99.5 wt % relative to 100 wt % of the positive electrode active material layer AML1. An amount of each of, or at least one of, the binder and the conductive material may be in a range of about 0.5 wt % to about 5 wt % relative to 100 wt % of the positive electrode active material layer AML1.

The binder may improve attachment of positive electrode active material particles to each other, and may improve attachment of the positive electrode active material to the current collector COL1. The binder may include, for example, at least one of polyvinyl alcohol, carboxymethyl cellulose, hydroxypropyl cellulose, diacetyl cellulose, polyvinylchloride, carboxylated polyvinylchloride, polyvinylfluoride, ethylene oxide-containing polymer, polyvinylpyrrolidone, polyurethane, polytetrafluoroethylene, polyvinylidene fluoride, polyethylene, polypropylene, styrene-butadiene rubber, (meth)acrylated styrene-butadiene rubber, epoxy resin, (meth)acrylic resin, polyester resin, or nylon, but the present disclosure is not limited thereto.

The conductive material may provide an electrode with conductivity, and any suitable conductive material that does not cause an adverse chemical change in a battery may be used as the conductive material. The conductive material may include, for example, a carbon-based material such as at least one of natural graphite, artificial graphite, carbon black, acetylene black, Ketjen black, carbon fiber, carbon nano-fiber, and carbon nano-tube; a metal powder or metal fiber containing one or more of copper, nickel, aluminum, and silver; a conductive polymer such as a polyphenylene derivative; or a mixture thereof.

Aluminum (Al) may be used as the current collector COL1, but the present disclosure is not limited thereto.

### Positive Electrode Active Material

The positive electrode active material in the positive electrode active material layer AML1 may include a compound (e.g., lithiated intercalation compound) that can reversibly intercalate and deintercalate lithium. For example, the positive electrode active material may include at least one kind of composite oxide including lithium and metal that is or includes at least one of cobalt, manganese, nickel, and a combination thereof.

The composite oxide may include a lithium transition metal composite oxide, for example, at least one of lithium-nickel-based oxide, lithium-cobalt-based oxide, lithium-manganese-based oxide, lithium-iron-phosphate-based compounds, cobalt-free nickel-manganese-based oxide, or a combination thereof.

For example, the positive electrode active material may include a compound expressed by one of chemical formulae below. LiₐA_{1-b}X_{b}O_{2-c}D_{c} (where 0.90≤a≤1.8, 0≤b≤0.5, and 0≤c≤0.05); LiₐMn_{2-b}X_{b}O_{4-c}D_{c} (where 0.90≤a≤1.8, 0≤b≤0.5, and 0≤c≤0.05); LiₐNi_{1-b-c}CO_{b}X_{c}O₂₋ₐDₐ (where 0.90≤a≤1.8, 0≤b≤0.5, 0≤c≤0.5, and 0≤≤≤2); LiₐNi_{1-b-c}Mn_{b}X_{c}O₂₋ₐDₐ (where 0.90≤a≤1.8, 0≤b≤0.5, 0≤c≤0.5, and 0≤α≤2); LiₐNi_{b}Co_{c}L¹_{d}GₑO₂ (where 0.90≤a≤1.8, 0≤b≤0.9, 0≤c≤0.5, 0≤d≤0.5, and 0≤e≤0.1); LiₐNiG_{b}O₂ (where 0.90≤a≤1.8 and 0.001≤b≤0.1); LiₐCoG_{b}O₂ (where 0.90≤a≤1.8 and 0.001≤b≤0.1); LiₐMn_{1-b}G_{b}O₂ (where 0.90≤a≤1.8 and 0.001≤b≤0.1); LiₐMn₂G_{b}O₄ (where 0.90≤a≤1.8 and 0.001≤b≤0.1); LiₐMn_{1-g}G_{g}PO₄ (where 0.90≤a≤1.8 and 0≤g≤0.5); Li_{(3-f)}Fe₂(PO₄)₃ (where 0≤f≤2); LiₐFePO₄ (where 0.90≤a≤1.8).

In the chemical formulae above, A may be or include at least one of Ni, Co, Mn, or a combination thereof, X may be or include at least one of Al, Ni, Co, Mn, Cr, Fe, Mg, Sr, V, a rare-earth element, or a combination thereof, D may be or include at least one of O, F, S, P, or a combination thereof, G may be or include at least one of Al, Cr, Mn, Fe, Mg, La, Ce, Sr, V, or a combination thereof, and L1 may be or include at least one of Mn, Al, or a combination thereof.

For example, the positive electrode active material may be or include a high-nickel-based positive electrode active material having a nickel amount of equal to or greater than about 80 mol %, equal to or greater than about 85 mol %, equal to or greater than about 90 mol %, equal to or greater than about 91 mol %, or equal to or greater than about 94 mol % and equal to or less than about 99 mol % relative to 100 mol % of metal devoid of lithium in the lithium transition metal composite oxide. The high-nickel-based positive electrode active material may achieve high capacity and thus may be applied to a high-capacity and high-density rechargeable lithium battery.

### Negative Electrode 20

The negative electrode 20 for the rechargeable lithium battery may include a current collector COL2 and a negative electrode active material layer AML2 positioned on the current collector COL2. The negative electrode active material layer AML2 may include a negative electrode active material, and may further include a binder and/or a conductive material (e.g., an electrically conductive material).

For example, the negative electrode active material layer AML2 may include a negative electrode active material in a range of about 90 wt % to about 99 wt %, a binder in a range of about 0.5 wt % to about 5 wt %, and a conductive material in a range of about 0 wt % to about 5 wt %.

The binder may improve attachment of negative electrode active material particles to each other, and may also improve attachment of the negative electrode active material to the current collector COL2. The binder may include a non-aqueous binder, an aqueous binder, a dry binder, or a combination thereof.

The non-aqueous binder may include at least one of polyvinyl chloride, carboxylated polyvinyl chloride, polyvinyl fluoride, ethylene propylene copolymer, polystyrene, polyurethane, polytetrafluoroethylene, polyvinylidene fluoride, polyethylene, polypropylene, polyamide imide, polyimide, or a combination thereof.

The aqueous binder may include at least one of styrene-butadiene rubber, (meth)acrylated styrene-butadiene rubber, (meth)acrylonitrile-butadiene rubber, (meth)acrylic rubber, butyl rubber, fluoro elastomer, polyethylene oxide, polyvinyl pyrrolidone, polyepichlorohydrin, polyphosphazene, poly(meth)acrylonitrile, ethylene propylene diene copolymer, polyvinyl pyridine, chlorosulfonated polyethylene, latex, polyester resin, (meth)acrylic resin, phenolic resin, epoxy resin, polyvinyl alcohol, or a combination thereof.

When an aqueous binder is used as the negative electrode binder, a cellulose-based compound capable of providing viscosity may further be included. The cellulose-based compound may include one or more of carboxymethyl cellulose, hydroxypropylmethyl cellulose, methyl cellulose, and alkali metal salts thereof. The alkali metal may include at least one of Na, K, or Li.

The dry binder may include a fibrillizable polymer material, for example, at least one of polytetrafluoroethylene, polyvinylidene fluoride, polyvinylidene fluoride-hexafluoropropylene copolymer, polyethylene oxide, or a combination thereof.

The conductive material may provide an electrode with conductivity, and any suitable conductive material that does not cause a chemical change in a battery may be used as the conductive material. For example, the conductive material may include a carbon-based material such as at least one of natural graphite, artificial graphite, carbon black, acetylene black, ketjen black, carbon fiber, carbon nanofiber, and carbon nanotube; a metal-based material in the form of a metal powder or metal fiber including one or more of copper, nickel, aluminum, and silver; a conductive polymer such as a polyphenylene derivative; or a mixture thereof.

The current collector COL2 may include at least one of a copper foil, a nickel foil, a stainless-steel foil, a titanium foil, a nickel foam, a copper foam, a polymer substrate coated with a conductive metal, or a combination thereof.

### Negative Electrode Active Material

The negative electrode active material in the negative electrode active material layer AML2 may include a material that can reversibly intercalate and deintercalate lithium ions, lithium metal, a lithium metal alloy, a material that can dope and de-dope lithium, or transition metal oxide.

The material that can reversibly intercalate and deintercalate lithium ions may include a carbon-based negative electrode active material, for example, crystalline carbon, amorphous carbon, or a combination thereof. For example, the crystalline carbon may include graphite such as non-shaped, sheet-shaped, flake-shaped, sphere-shaped, or fiber-shaped natural or artificial graphite, and the amorphous carbon may include soft carbon, hard carbon, mesophase pitch carbon, or calcined coke.

The lithium metal alloy may include an alloy of lithium and metal that is or includes at least one of Na, K, Rb, Cs, Fr, Be, Mg, Ca, Sr, Si, Sb, Pb, In, Zn, Ba, Ra, Ge, Al, and Sn.

The material that can dope and de-dope lithium may include a Si-based negative electrode active material or a Sn-based negative electrode active material. The Si-based negative electrode active material may include at least one of silicon, silicon-carbon composite, SiOₓ (where 0<x≤2), Si-Q alloy (where Q is or includes at least one of alkali metal, alkaline earth metal, Group 13 element, Group 14 element (except for Si), Group 15 element, Group 16 element, transition metal, a rare-earth element, or a combination thereof), or a combination thereof. The Sn-based negative electrode active material may include at least one of Sn, SnO₂, a Sn-based alloy, a combination thereof.

The silicon-carbon composite may be or include a composite of silicon and amorphous carbon. According to an example embodiment, the silicon-carbon composite may have a structure in which the amorphous carbon is coated on a surface of the silicon particle. For example, the silicon-carbon composite may include a secondary particle (core) in which primary silicon particles are assembled, and an amorphous carbon coating layer (shell) positioned on a surface of the secondary particle. The amorphous carbon may also be positioned between the primary silicon particles, and for example, the primary silicon particles may be coated with the amorphous carbon. The secondary particles may be dispersed in an amorphous carbon matrix.

The silicon-carbon composite may further include crystalline carbon. For example, the silicon-carbon composite may include a core including crystalline carbon and silicon particles, and may also include an amorphous carbon coating layer positioned on a surface of the core.

The Si-based negative electrode active material or the Sn-based negative electrode active material may be combined with a carbon-based negative electrode active material.

### Separator 30

Based on a type of the rechargeable lithium battery, the separator 30 may be present between positive electrode 10 and the negative electrode 20. The separator 30 may include one or more of polyethylene, polypropylene, and polyvinylidene fluoride, and may have a multi-layered separator thereof such as a at least one of polyethylene/polypropylene bi-layered separator, a polyethylene/polypropylene/polyethylene tri-layered separator, and a polypropylene/polyethylene/polypropylene tri-layered separator.

The separator 30 may include a porous substrate and a coating layer positioned on one surface, or on opposite surfaces, of the porous substrate, the coating layer including an organic material, an inorganic material, or a combination thereof.

The porous substrate may be or include a polymer layer including at least one of polyolefin such as polyethylene and polypropylene, polyester such as polyethylene terephthalate and polybutylene terephthalate, polyacetal, polyamide, polyimide, polycarbonate, polyetherketone, polyaryletherketone, polyetherimide, polyamideimide, polybenzimidazole, polyethersulfone, polyphenyleneoxide, cyclic olefin copolymer, polyphenylenesulphide, polyethylene naphthalate, glass fiber, Teflon, and polytetrafluoroethylene, or may be or include a copolymer or mixture including two or more of the materials mentioned above.

The organic material may include a polyvinylidenefluoride-based copolymer or a (meth)acrylic copolymer.

The inorganic material may include an inorganic particle such as or including at least one of Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, Boehmite, or a combination thereof, but the present disclosure is not limited thereto.

The organic material and the inorganic material may be mixed in one coating layer, or may be present as a stack of a coating layer including the organic material, and a coating layer including an inorganic material.

### Electrolyte ELL

The electrolyte ELL for a rechargeable lithium battery may include a non-aqueous organic solvent and a lithium salt.

The non-aqueous organic solvent may constitute a medium for transmitting ions that participate in an electrochemical reaction of the battery.

The non-aqueous organic solvent may include at least one of a carbonate-based solvent, an ester-based solvent, an ether-based solvent, a ketone-based solvent, an alcohol-based solvent, an aprotic solvent, or a combination thereof.

The carbonate-based solvent may include at least one of dimethyl carbonate (DMC), diethyl carbonate (DEC), dipropyl carbonate (DPC), methylpropyl carbonate (MPC), ethylpropyl carbonate (EPC), methylethyl carbonate (MEC), ethylene carbonate (EC), propylene carbonate (PC), or butylene carbonate (BC).

The ester-based solvent may include at least one of methyl acetate, ethyl acetate, n-propyl acetate, dimethyl acetate, methyl propionate, ethyl propionate, decanolide, mevalonolactone, valerolactone, or caprolactone.

The ether-based solvent may include at least one of dibutyl ether, tetraglyme, diglyme, dimethoxyethane, 2-methyltetrahydrofuran, 2.5-dimethyltetrahydrofuran, or tetrahydrofuran. The ketone-based solvent may include cyclohexanone. The alcohol-based solvent may include ethyl alcohol or isopropyl alcohol. The aprotic solvent may include at least one of nitriles such as R—CN (where R is a hydrocarbon group having a C2 to C20 linear, branched, or cyclic structure and may include a double bond, an aromatic ring, or an ether group); amides such as dimethylformamide; dioxolanes such as 1,3-dioxolane or 1.4-dioxolane; or sulfolane.

The non-aqueous organic solvent may be used alone, or in a mixture of two or more solvents.

For example, when a carbonate-based solvent is used, a cyclic carbonate and a chain carbonate may be mixed, and the cyclic carbonate and the chain carbonate may be mixed in a volume ratio in a range of about 1:1 to about 1:9.

The lithium salt may be or include a material that dissolves in the non-aqueous organic solvent to constitute a supply source of lithium ions in a battery, and contributes to enabling a basic operation of a rechargeable lithium battery and in promoting the movement of lithium ions between positive and negative electrodes. The lithium salt may include, for example, at least one of LiPF₆, LiBF₄, LiSbF₆, LiAsF₆, LiClO₄, LiAlO₂, LiAlCl₄, LiPO₂F₂, LiCl, LiI, LiN(SO₃C₂F₅)₂, Li(FSO₂)₂N (lithium bis(fluorosulfonyl)imide, LiFSI), LiC₄F₉SO₃, LiN(CₓF₂ₓ₊₁SO₂)(C_{y}F_{2y+1}SO₂) (where x and y are integers in a range of 1 to 20), lithium trifluoromethane sulfonate, lithium tetrafluoroethanesulfonate, lithium difluoro (oxalato) borate (LiDFOB), lithium difluorobis(oxalato)phosphate (LiDFBOP), or lithium bis(oxalato) borate (LiBOB).

### Rechargeable Lithium Battery

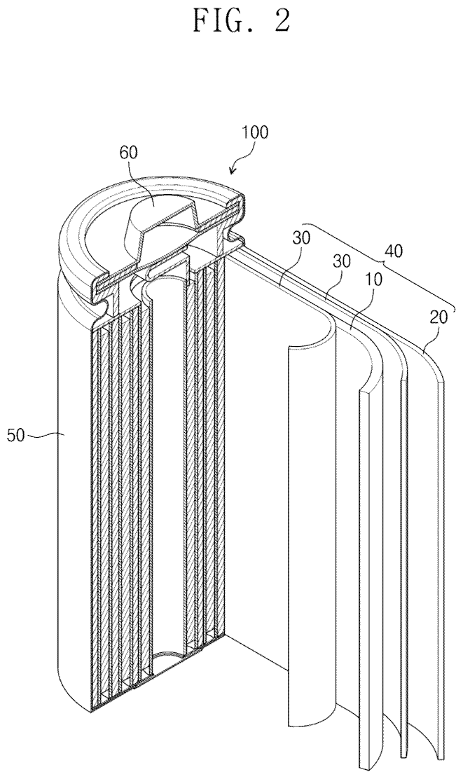

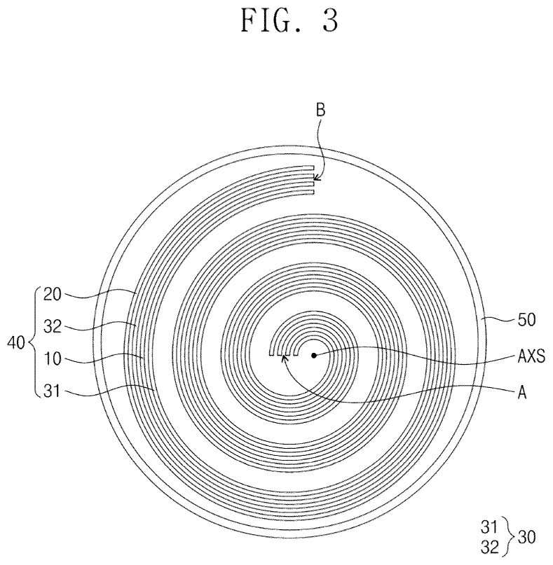

FIG. 2 is a schematic diagram illustrating a rechargeable lithium battery according to an example embodiment of the present disclosure. FIG. 3 is a plan view of a rechargeable lithium battery according to an example embodiment of the present disclosure.

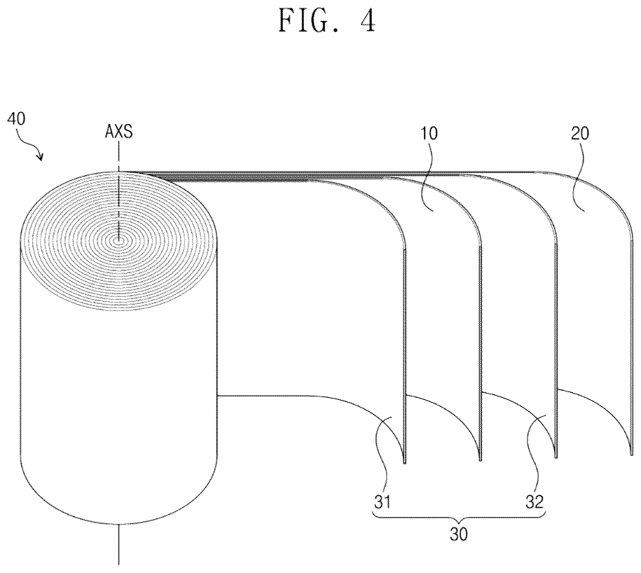

FIG. 4 is a schematic diagram illustrating an electrode assembly according to an example embodiment of the present disclosure.

Referring to FIG. 2-FIG. 4, a rechargeable lithium battery 100 according to an example embodiment of the present disclosure may include an electrode assembly 40, and a cylindrical case 50 housing the electrode assembly 40.

The electrode assembly 40 may include a positive electrode 10, a negative electrode 20, and a separator 30 between the positive electrode 10 and the negative electrode 20.

The positive electrode 10 of the electrode assembly 40 may include a positive electrode current collector, and a positive electrode active material layer on the positive electrode current collector. The positive electrode active material layer may be provided on at least one surface of the positive electrode current collector. The description of the positive electrode 10 may be substantially the same as the description above with reference to FIG. 1.

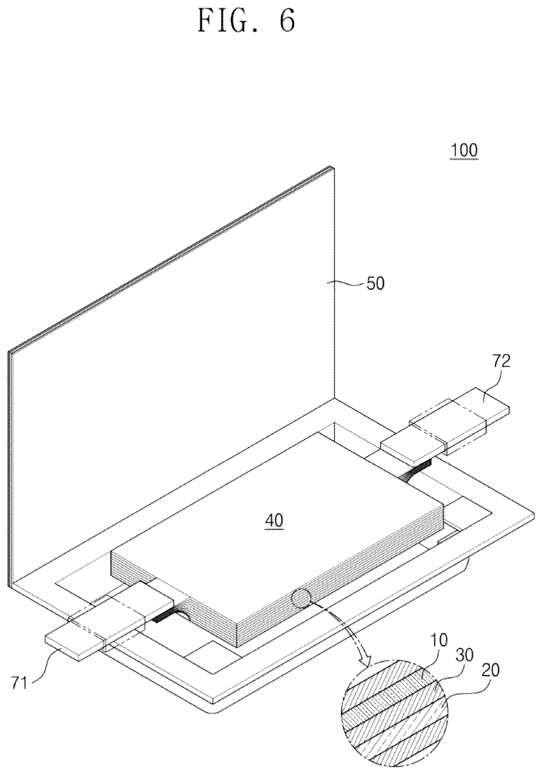

The negative electrode 20 of the electrode assembly 40 may include a negative electrode current collector, and a negative electrode active material layer on the negative electrode current collector. The negative electrode active material layer may be provided on at least one surface of the negative electrode current collector. The negative electrode 20 according to an example embodiment of the present disclosure is described below with reference to FIG. 9 to FIG. 11.

The separator 30 of the electrode assembly 40 may be interposed between the positive electrode active material layer and the negative electrode active material layer. The separator 30 may include a first separator 31 and a second separator 32. The description of the separator 30 may be substantially the same as the above description with reference to FIG. 1.

The electrode assembly 40 may have a structure in which the first separator 31, the positive electrode 10, the second separator 32, and the negative electrode 20 are stacked, e.g., sequentially stacked. Alternatively, the electrode assembly 40 may have a structure in which the positive electrode 10, the first separator 31, the negative electrode 20, and the second separator 32 are stacked, e.g., sequentially stacked. In this case, the positions of the positive electrode 10 and the negative electrode 20 may be changed with respect to each other.

The electrode assembly 40 may have a jelly-roll structure wound in a cylindrical shape along a circumferential direction about a winding axis AXS.

Although not explicitly shown in FIG. 2 and FIG. 3, the electrode assembly 40 may be housed in the cylindrical case 50 with an electrolyte (not shown). In other words, the positive electrode 10, the negative electrode 20, and the separator 30 may be accommodated in the cylindrical case 50 in a state impregnated with the electrolyte.

The rechargeable lithium battery 100 may further include a sealing member 60 that seals the cylindrical case 50, as shown in FIG. 2. During the manufacturing process of the rechargeable lithium battery 100, an upper portion of the cylindrical case 50 may be in an open state. The electrode assembly 40 may be inserted through the open upper portion of the cylindrical case 50. By covering the open upper portion of the cylindrical case 50 with the sealing member 60, the internal space of the cylindrical case 50 can be sealed.

The cylindrical case 50 may include at least one of steel, nickel-plated steel, stainless-steel, aluminum, or an aluminum alloy.

In general, in the case of the cylindrical rechargeable lithium battery, the electrolyte may be consumed as charging and discharging are repeated. Due to the characteristics of the electrode assembly wound in a jelly-roll structure, a winding center portion from which winding begins may have a dense electrode configuration because of the small radius of curvature thereof. As a result, when the amount of the electrolyte is reduced, penetration of the electrolyte into the interior of the electrode at the winding center portion of the electrode assembly may become challenging. This deterioration in electrolyte impregnation may cause lithium to be precipitated on the surface of the negative electrode.

The negative electrode for a jelly-roll electrode according to an example embodiment of the present disclosure may locally reduce a mixture density of the negative electrode active material layer at the winding center portion. Accordingly, lithium ion mobility and electrolyte impregnation characteristics at the winding center portion may be improved, thereby reducing or preventing lithium deposition caused by insufficient electrolyte impregnation. As a result, the rechargeable lithium battery including the negative electrode may exhibit improved cycle-life characteristics.

Each of FIG. 5 to FIG. 7 is a schematic diagram illustrating a rechargeable lithium battery according to an example embodiment of the present disclosure. Hereinafter, a detailed description of technical features that overlap with those described with reference to FIG. 2 to FIG. 4 are omitted, and differences are described in detail below.

Referring to FIG. 2 and FIG. 5 to FIG. 7, a rechargeable lithium battery 100 according to an example embodiment of the present disclosure may include an electrode assembly 40 and a case 50 housing the electrode assembly 40.

The electrode assembly 40 may include a positive electrode 10, a negative electrode 20, and a separator 30 between the positive electrode 10 and the negative electrode 20.

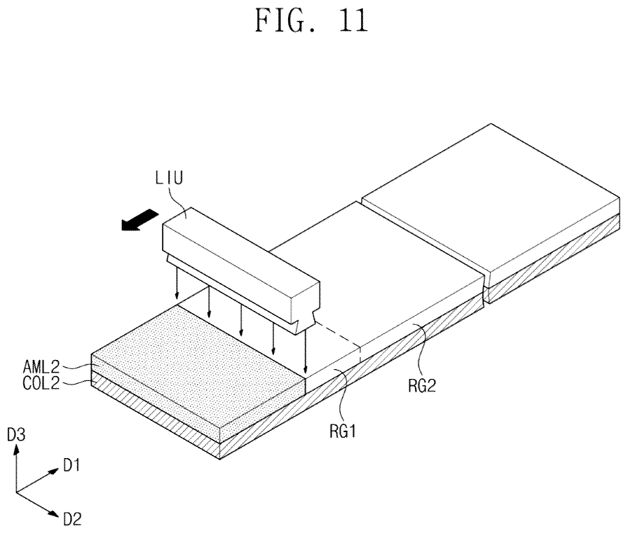

The negative electrode 20 according to another example embodiment of the present disclosure is described below with reference to FIG. 12 to FIG. 15.

Although not explicitly shown in FIG. 2, and FIG. 5 to FIG. 7, the electrode assembly 40 may be housed in the case 50 with an electrolyte (not shown). In other words, the positive electrode 10, the negative electrode 20, and the separator 30 may be accommodated in the case 50 in a state impregnated with the electrolyte.

The case 50 may be at least one of a cylindrical case, a prismatic case, or a pouch. The rechargeable lithium battery 100 may be classified into a cylindrical type, a prismatic type, a pouch type, and the like according to the shape. FIG. 2 is a cylindrical battery, FIG. 5 is a prismatic type battery, and FIG. 6 and FIG. 7 are pouch-type batteries. The rechargeable lithium battery 100 may include a sealing member 60 that seals the case 50 as shown in FIG. 2. In addition, as shown in FIG. 5, the rechargeable lithium battery 100 may include a positive electrode lead tab 11, a positive electrode terminal 12 connected to the positive electrode lead tab 11, a negative electrode lead tab 21, and a negative electrode terminal 22 connected to the negative electrode lead tab 21. As shown in FIG. 6 and FIG. 7, the rechargeable lithium battery 100 may include an electrode tab 70 illustrated in FIG. 7, or a positive electrode tab 71 and a negative electrode tab 72 illustrated in FIG. 6, the electrode tabs 70/71/72 forming an electric path for externally inducing a current generated in the electrode assembly 40.

In general, in the case of the rechargeable lithium battery, the electrolyte may be consumed as charging and discharging are repeated. Due to the characteristics of the electrode assembly applied to a large-sized battery, which have relatively large electrode plate area, when the amount of the electrolyte is reduced, penetration of the electrolyte into the interior of the electrode at the central portion of the electrode may become difficult. This deterioration in electrolyte impregnation may cause lithium to be precipitated on the surface of the negative electrode.

The negative electrode for a rechargeable lithium battery according to another example embodiment of the present disclosure may locally reduce a mixture density of the negative electrode active material layer at the central portion of the negative electrode. Accordingly, lithium ion mobility and electrolyte impregnation characteristics at the central portion of the negative electrode may be improved, thereby reducing or preventing lithium deposition caused by insufficient electrolyte impregnation. As a result, the rechargeable lithium battery including the negative electrode may exhibit improve cycle-life characteristics.

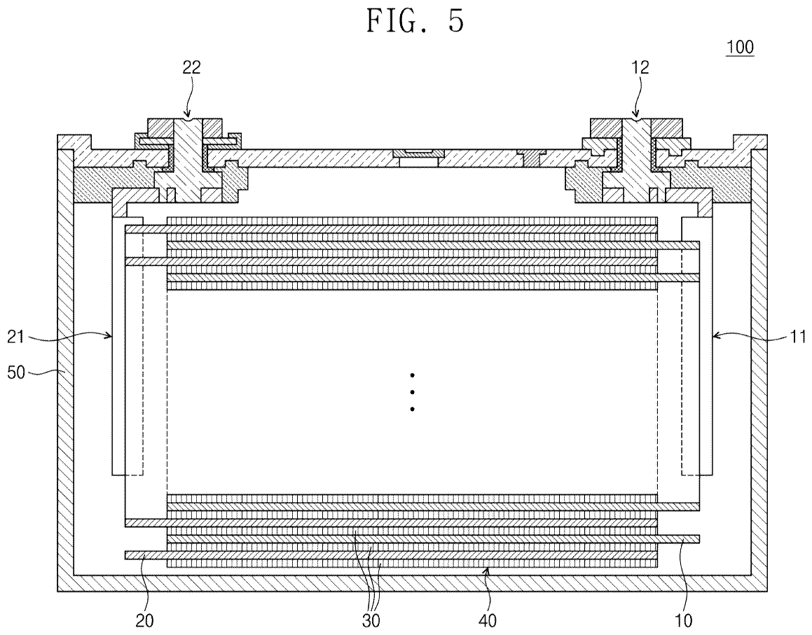

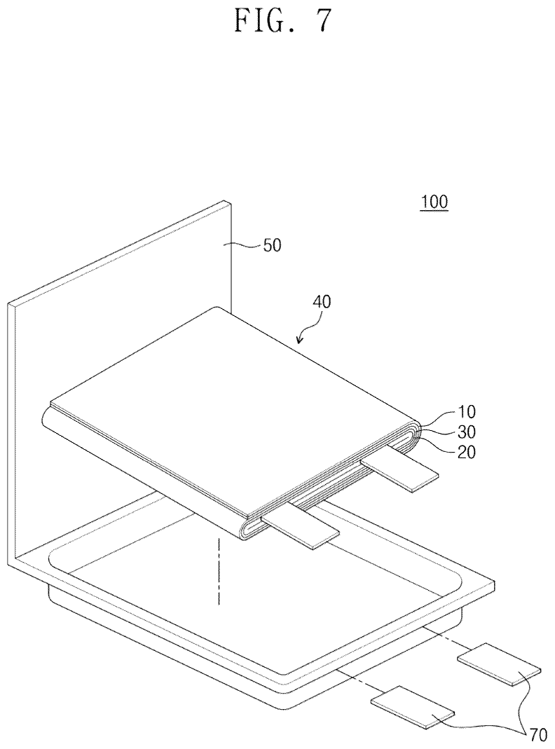

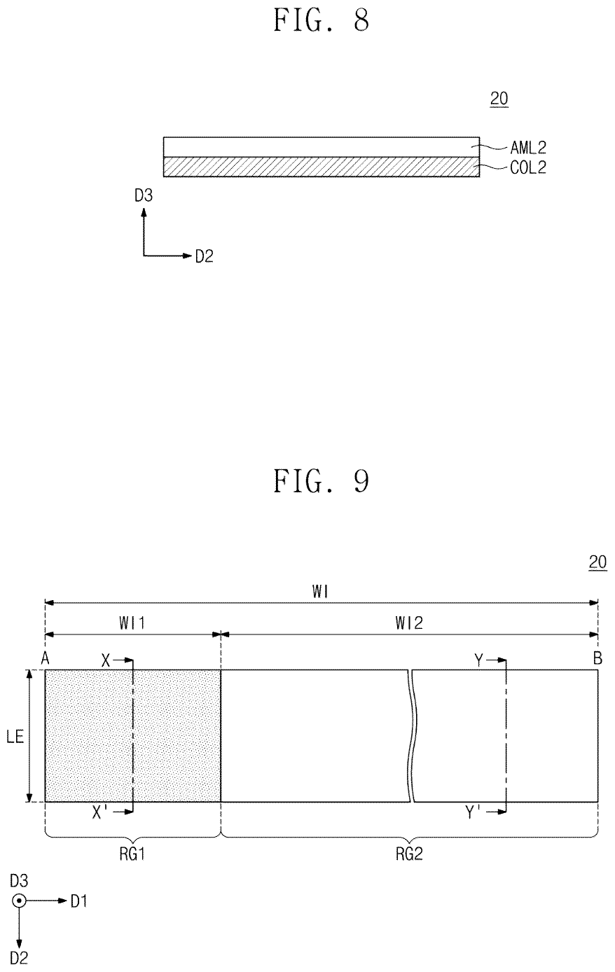

FIG. 8 is a cross-sectional view of a negative electrode for a jelly-roll electrode according to an example embodiment of the present disclosure. FIG. 9 is a plan view of a negative electrode for a jelly-roll electrode according to an example embodiment of the present disclosure. FIG. 10A is a cross-sectional view taken along line X-X′ of FIG. 9. FIG. 10B is a cross-sectional view taken along line Y-Y′ of FIG. 9.

Referring to FIG. 8, a negative electrode for a jelly-roll electrode according to an example embodiment of the present disclosure may include the negative electrode current collector COL2, and the negative electrode active material layer AML2 on the negative electrode current collector COL2, as described above.

The negative electrode current collector COL2 may include at least one of copper foil, nickel foil, stainless-steel foil, titanium foil, nickel foam, copper foam, a polymer substrate coated with a conductive metal, or a combination thereof.

A thickness of the negative electrode current collector COL2 may be in a range of about 1 μm to about 20 μm. For example, the thickness of the negative electrode current collector COL2 may be about 5 μm to about 15 μm, about 7 μm to about 10 μm, or about 8 μm to about 10 μm.

Referring to FIG. 9, FIG. 10A and FIG. 10B, the negative electrode active material layer AML2 may include a negative electrode active material AM, and may further include a binder BND and/or a conductive material. The negative electrode active material layer AML2 may have a long axis in one direction (e.g., a first direction D1). The negative electrode active material layer AML2 may extend in the first direction D1 on the negative electrode current collector COL2.

The negative electrode active material layer AML2 may include a first region RG1 and a second region RG2 sequentially arranged, along the first direction D1.

Referring again to FIG. 3, among both ends of the negative electrode active material layer AML2, the end wound firstly may be defined as a winding leading end A, and the end wound lastly may be defined as a winding trailing end B. The winding leading end A of the negative electrode active material layer AML2 may be located at a winding center portion of the wound electrode assembly 40. The winding trailing end B of the negative electrode active material layer AML2 may be located at a winding outer portion of the wound electrode assembly 40.

Referring to FIG. 9, the first region RG1 may be defined as a region extending from one end (e.g., winding leading end A) of the negative electrode active material layer AML2 to a point corresponding to about 0.5% to about 5% of a length of the long axis. For example, the first region RG1 may correspond to a range of about 1% to about 3% of the length of the long axis of the negative electrode active material layer AML2. The first region RG1 may refer to a region wound from one end A of the negative electrode active material layer AML2 by about 1 turn to about 3 turns during cylindrical winding of the electrode assembly. The first region RG1 may be located in a winding center portion of the wound electrode assembly. The first region RG1 may be a region in which electrolyte impregnation is relatively challenging. The second region RG2 may refer to a remaining region of the negative electrode active material layer AML2 excluding the first region RG1. The second region RG2 may be a region in which electrolyte impregnation is readily possible.

The first region RG1 may have a first width WI1 in the first direction D1. The second region RG2 may have a second width WI2 in the first direction D1. The second width WI2 may be greater than the first width WI1. The negative electrode active material layer AML2 may have a width W1 in the first direction D1. The negative electrode active material layer AML2 may have a length LE in a second direction D2 perpendicular to the first direction D1. The width W1 of the negative electrode active material layer AML2 in the first direction D1 may be a sum of the first width WI1 and the second width WI2. The width W1 (i.e., long axis length) of the negative electrode active material layer AML2 in the first direction D1 may refer to the length of the long axis of the negative electrode active material layer AML2. The first width WI1 may be in a range of about 0.5% to about 5% of the long axis length W1 of the negative electrode active material layer AML2. The second width WI2 may be in a range of about 95% to about 99.5% of the long axis length W1 of the negative electrode active material layer AML2. For example, the long axis length W1 may be in a range of about 900 mm to about 1300 mm, and the first width WI1 may be in a range of about 4.5 mm to about 50 mm.

Referring to FIG. 9 and FIG. 10A, the first region RG1 may include a surface portion SP and a deep portion DP. The first region RG1 may correspond to a region where the binder BND in the surface portion SP is removed by, e.g., a selective surface treatment process described below. Accordingly, an amount of the binder BND in the surface portion SP may be less than the amount of the binder BND in the deep portion DP. A porosity of the surface portion SP may be greater than the porosity of the deep portion DP. In this case, the surface treatment process may not affect other components such as, e.g., the negative electrode active material AM and the conductive material. That is, the negative electrode active material AM and/or the conductive material may have a uniform, or substantially uniform, distribution in the negative electrode active material layer AML2.

In the present disclosure, the surface portion SP may refer to a region extending from a surface of the negative electrode active material layer AML2 toward the negative electrode current collector COL2 up to a depth in a range of about 10% to about 30% of a thickness of the negative electrode active material layer AML2. In the present disclosure, the deep portion DP may refer to the remaining region of the negative electrode active material layer AML2 excluding the surface portion SP. The deep portion DP may be a region between the surface portion SP and the negative electrode current collector COL2. The surface portion SP and the deep portion DP may be adjacent to each other in a third direction D3. For example, the surface portion SP may correspond to about 20% of the thickness of the negative electrode active material layer AML2. The deep portion DP may correspond to about 80% of the thickness of the negative electrode active material layer AML2.

According to an example embodiment of the present disclosure, an amount of the binder BND in the first region RG1 may be less than the amount of the binder BND in the second region RG2 by the surface treatment process selectively performed on the first region RG1. A loading level of the first region RG1 may be substantially the same as or different from a loading level of the second region RG2. The difference in the loading level between the first and second regions RG1 and RG2 may be due to a difference in the amount of the binder between the first and the second regions RG1 and RG2. This may be due to the fact that the loading level of the first region RG1 may be reduced compared to the second region RG2 by selectively reducing the binder amount of the first region RG1. However, since the amount of the binder BND reduced by the surface treatment process in the first region RG1 is relatively small, the difference in the loading levels between the first and second regions RG1 and RG2 may be negligible, or the loading levels may be substantially equal.

In the present disclosure, the term “loading level” may refer to a value calculated by dividing the weight of the negative electrode active material layer AML2 (e.g., the negative electrode active material AM, the binder BND, the conductive material, and the like) by the area thereof. The area of the negative electrode active material layer may be calculated by multiplying the width W1 in the first direction D1 by the length LE in the second direction D2. The loading level may refer to the loading level on one side of the negative electrode active material layer AML2.

For example, the loading level for each region may be calculated by the following method. First, the negative electrode 20 may be cut along an interface between the first region RG1 and the second region RG2, thereby separating the negative electrode 20 into the first and second regions RG1 and RG2. Thereafter, the loading level may be obtained for each of the resulting first and second regions RG1 and RG2. At this time, the interface between the first and second regions RG1 and RG2 may be visually identified. For example, since the first region RG1 has a relatively dark color and the second region RG2 has a relatively light color, the interface may be defined as a point at which a sharp color change occurs. The loading level of each of, or at least one of, the first and second regions RG1 and RG2 may be calculated by Equations 1-1 and 2-1 below.

$$Loading level of the first region RG 1 ( mg / {cm}^{2} ) = \{ Weight of the first region RG 1 / ( Width WI 1 of the first region RG 1 in the first direction D 1 \times Length LE of the first region RG 1 in the second direction D 2 ) \} . \qquad Equation 1 - 1$$

$$Loading level of the second region RG 2 ( mg / {cm}^{2} ) = \{ Weight of the second region RG 2 / ( Width WI 2 of the second region RG 2 in the first direction D 1 \times Length LE of the second region RG 2 in the second direction D 2 ) \} . \qquad Equation 2 - 1$$

Herein, the weight of each of the first and second regions RG1 and RG2 may refer to the weight of the components of the negative electrode active material layer AML2, excluding the negative electrode current collector COL2 from the negative electrode.

For example, the loading level of the first region RG1 may be substantially the same as the loading level of the second region RG2. That is, a ratio of the loading level of the first region RG1 to the loading level of the second region RG2 may be about 100%.

As another example, the loading level of the first region RG1 may be less than the loading level of the second region RG2. A ratio of the loading level of the first region RG1 to the loading level of the second region RG2 may be greater than or equal to about 95% and less than about 100%. For example, the ratio of the loading level of the first region RG1 to the loading level of the second region RG2 may be in a range of about 95% to about 99.9%, about 95% to about 99.5%, about 96% to about 99%, or about 97% to about 99%.

When the ratio of the loading level of the first region RG1 to the loading level of the second region RG2 is below the above-described range, asymmetry or imbalance may occur in electrode expansion, adhesion to the negative electrode active material, or electrochemical reactions due to an excessive difference in binder amount between the first and second regions RG1 and RG2. This may lead to deterioration of mechanical properties, cell performance, and thermal stability of the rechargeable lithium battery. When the ratio of the loading level of the first region RG1 to the loading level of the second region RG2 satisfies the above range, enhanced electrolyte impregnation characteristics and lithium deposition reduction or suppression may be achieved. The above-described effects may also be achieved even when the loading levels of the first and second regions RG1 and RG2 are substantially the same.

The loading level of the first region RG1 and the loading level of the second region RG2 may each be in a range of about 5 mg/cm² to about 15 mg/cm². For example, the loading level of each of, or at least one of, the first and second regions RG1, RG2 may be in a range of about 7 mg/cm² to about 15 mg/cm², about 7 mg/cm² to about 12 mg/cm², or about 8 mg/cm² to about 12 mg/cm².

Referring to FIG. 9, FIG. 10A, and FIG. 10B, the first region RG1 may have a first thickness TK1. The second region RG2 may have a second thickness TK2. The first thickness TK1 and the second thickness TK2 may be different from each other. This may be because, the removal of the binder from the surface portion SP of the first region RG1 by the selective surface treatment process causes rearrangement of the particles or an increase in the spacing between the particles, resulting in increased porosity and thickness in the surface portion SP of the first region RG1.

In the present disclosure, the term “thickness” may be measured using a thickness measuring instrument or determined from images obtained by an optical microscope such as a scanning electron microscope (SEM). The thickness measurement method is not particularly limited as long as the method is known in the art. For example, the thickness of each of the first and second regions RG1 and RG2 may be measured using a micrometer, excluding the thickness of the negative electrode current collector COL2 from the thickness of the negative electrode 20. When the negative electrode active material layer is non-uniformly formed, the thicknesses of each of the first and second regions RG1 and RG2 may be an average thickness in each region, or the maximum thickness at the thickest location in each region. For example, the thickness of each of the first and second regions RG1 and RG2 may be the average thickness. Herein, the thickness of each region may refer to the thickness measured at a cross-section of the negative electrode active material layer AML2, that is, the thickness of one side thereof.

In an example embodiment, the first thickness TK1 may be greater than the second thickness TK2. A ratio of the first thickness TK1 to the second thickness TK2 may be greater than about 100% and less than or equal to about 120%. For example, the ratio of the first thickness TK1 to the second thickness TK2 may be in a range of about 100.1% to about 117%, about 100.5% to about 115%, about 100.5 to about 110%, or about 101% to about 105%.

When the ratio of the first thickness TK1 to the second thickness TK2 is greater than the above-described range, deformation may occur during winding due to thickness imbalance between the first and second regions RG1 and RG2, and cracks may form caused by differences in expansion rate.

The first thickness TK1 may be in a range of about 50 μm to about 125 μm. For example, the first thickness TK1 may be about 50 μm to about 120 μm, about 50 μm to about 110 μm, or about 60 μm to about 100 μm.

The second thickness TK2 may be in a range of about 50 μm to about 110 μm. For example, the second thickness TK2 may be about 50 μm to about 100 μm, about 50 μm to about 90 μm, or about 60 μm to about 90 μm.

According to an example embodiment of the present disclosure, a mixture density of the first region RG1 may be less than the mixture density of the second region RG2. This difference may be due to the fact that the first region RG1 has a greater thickness than the second region RG2. Alternatively, this difference may be due to the fact that the first region RG1 has a smaller loading level and a greater thickness than the second region RG2.

In the present disclosure, the term “mixture density” may refer to a value calculated by dividing the weight of the negative electrode active material layer AML2 (e.g., the negative electrode active material, the conductive material, the binder, and the like) of the negative electrode 20, excluding the negative electrode current collector COL2, by the volume thereof. The volume of the negative electrode active material layer AML2 may be calculated by multiplying the area thereof by the thickness thereof. The area of the negative electrode active material layer AML2 may be substantially the same as described above. The thickness of the negative electrode active material layer AML2 may refer to the thickness in the third direction D3.

For example, as described above, the mixture density for each region may be obtained by cutting the negative electrode 20 along an interface between the first region RG1 and the second region RG2 to separate the two regions RG1 and RG2. Thereafter, the mixture density of each of the resulting first and second regions RG1 and RG2 may be calculated by Equations 3-1 and 4-1 below.

$$Mixture density of the first region RG 1 ( g / cc ) = ( Loading level of the first region RG 1 / Thickness TK 1 of the first region RG 1 ) . \qquad Equation 3 - 1$$

$$Mixture density of the second region RG 2 ( g / cc ) = ( Loading level of the second region RG 2 / Thickness TK 2 of the second region RG 2 ) . \qquad Equation 4 - 1$$

Herein, the loading level of each of the first and second regions RG1 and RG2 may be the same as the loading level described above. The thickness of each of the first and second regions RG1 and RG2 may refer to the average thickness for each region.

A ratio of the mixture density of the first region RG1 to the mixture density of the second region RG2 may be greater than or equal to about 85% and less than about 100%. For example, the ratio of the mixture density of the first region RG1 to the mixture density of the second region RG2 may be in a range of about 85% to about 99.9%, about 90% to about 99.5%, or about 95% to about 99%.

When the ratio of the mixture density of the first region RG1 to the mixture density of the second region RG2 is less than the above-described range, asymmetry or imbalance may occur in electrode expansion, adhesion to the negative electrode active material, or electrochemical reactions due to an excessive difference in binder amount or thickness between the first and second regions RG1 and RG2. This may lead to deterioration in mechanical properties, cell performance, and thermal stability of the rechargeable lithium battery. When the ratio of the mixture density of the first region RG1 to the mixture density of the second region RG2 satisfies the above range, the difference in the mixture density between the first and second regions RG1 and RG2 may improve electrolyte impregnation and reduce or suppress lithium deposition.

The mixture density of the first region RG1 may be in a range of about 1.2 g/cc to about 1.7 g/cc. For example, the mixture density of the first region RG1 may be about 1.25 g/cc to about 1.65 g/cc, about 1.3 g/cc to about 1.6 g/cc, or from about 1.4 g/cc to about 1.6 g/cc.

The mixture density of the second region RG2 may be in a range of about 1.4 g/cc to about 1.7 g/cc. For example, the mixture density of the second region RG2 may be about 1.45 g/cc to about 1.7 g/cc, or about 1.5 g/cc to about 1.7 g/cc.

The negative electrode 20 for the jelly-roll electrode according to an example embodiment of the present disclosure may include the first region RG1 and the second region RG2 having different mixture densities. Since the first region RG1 located in the winding center portion where winding begins has a relatively lower mixture density, lithium ion mobility and electrolyte impregnation characteristics may be improved. Accordingly, lithium deposition due to insufficient electrolyte impregnation and deterioration of cell performance may be reduced or suppressed. As a result, a rechargeable lithium battery having a high capacity and improved cycle-life may be provided.

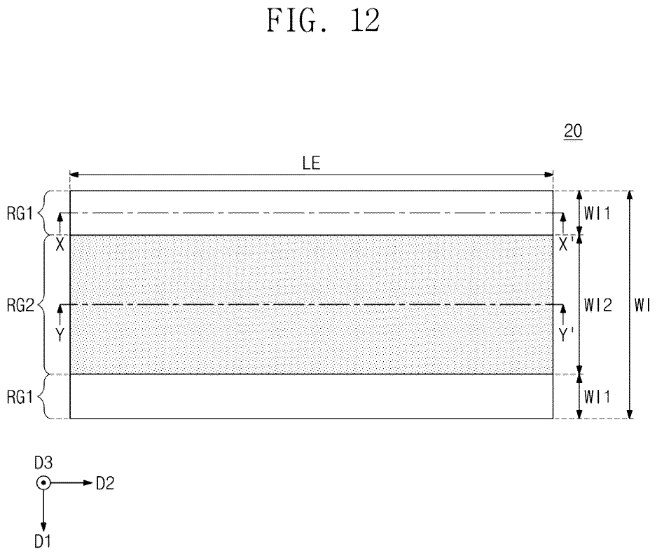

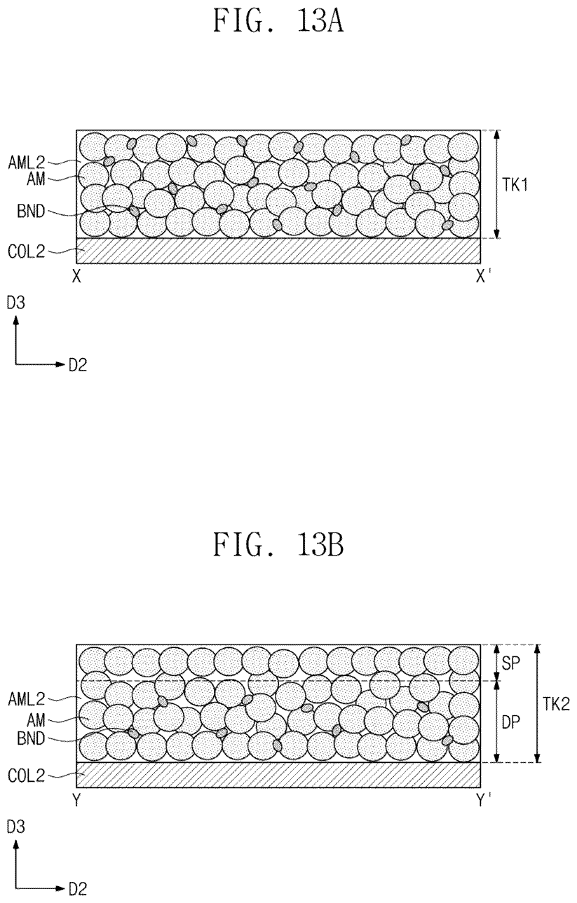

Hereinafter, a negative electrode for a rechargeable lithium battery according to another example embodiment of the present disclosure is described in more detail with reference to FIG. 12 and FIG. 13. It should be understood that the terms or reference numerals used in the example embodiment are provided merely for the purpose of describing the example embodiment, and are not intended to be interpreted as having the same meaning in other example embodiments.

FIG. 12 is a plan view of a negative electrode for a rechargeable lithium battery according to another example embodiment of the present disclosure. FIG. 13A is a cross-sectional view taken along line X-X′ of FIG. 12. FIG. 13B is a cross-sectional view taken along line Y-Y′ of FIG. 12.

Referring again to FIG. 8, the negative electrode 20 for a rechargeable lithium battery according to another example embodiment of the present disclosure may include a negative electrode current collector COL2, and a negative electrode active material layer AML2 on the negative electrode current collector COL2.

The negative electrode current collector COL2 may include at least one of copper foil, nickel foil, stainless-steel foil, titanium foil, nickel foam, copper foam, a polymer substrate coated with a conductive metal, or a combination thereof.

A thickness of the negative electrode current collector COL2 may be in a range of about 1 μm to about 20 μm. For example, the thickness of the negative electrode current collector COL2 may be about 5 μm to about 15 μm, about 7 μm to about 10 μm, or about 8 μm to about 10 μm.

Referring to FIG. 12, FIG. 13A and FIG. 13B, the negative electrode active material layer AML2 may include a negative electrode active material AM, and may further include a binder BND and/or a conductive material. The negative electrode active material layer AML2 may have a short axis in one direction (e.g., a first direction D1). The negative electrode active material layer AML2 may extend in the second direction D2 on the negative electrode current collector COL2.

The negative electrode active material layer AML2 may include first regions RG1 opposite to each other in the first direction D1, and a second region RG2 between the first regions RG1.

Each of, or at least one of, the first regions RG1 may be spaced apart from each other in the first direction D1. The first regions RG1 may be located in edge portions of the negative electrode 20. The first regions RG1 may be regions in which electrolyte impregnation is readily possible. The second region RG2 may be interposed between the first regions RG1. The first regions RG1 may be provided on both sides of the second region RG2 in the first direction D1. The second region RG2 may be located in a central portion of the negative electrode 20. The second region RG2 may be a region in which electrolyte impregnation is relatively challenging.

Each of, or at least one of, the first regions RG1 may have a first width WI1 in the first direction D1. The second region RG2 may have a second width WI2 in the first direction D1. The second width WI2 may be greater than the first width WI1. The negative electrode active material layer AML2 may have a width W1 in the first direction D1. The negative electrode active material layer AML2 may have a length LE in a second direction D2 perpendicular to the first direction D1. The width W1 (i.e., short axis length) of the negative electrode active material layer AML2 in the first direction D1 may refer to a length of the short axis of the negative electrode active material layer AML2. The second width WI2 may be about 40% to about 80% of the short axis length W1 of the negative electrode active material layer AML2. The first width WI1 may be about 10% to about 30% of the short axis length W1 of the negative electrode active material layer AML2. For example, the short axis length W1 may be in a range of about 5 cm to about 7 cm, and the second width WI2 may be in a range of about 2 cm to about 5.5 cm. However, the present disclosure is not limited thereto, and the short axis length W1 may be adjusted as desired depending on the shape of the battery.

Referring to FIG. 12 and FIG. 13B, the second region RG2 may include a surface portion SP and a deep portion DP. The second region RG2 may correspond to a region where the binder BND in the surface portion SP is removed by, e.g., a selective surface treatment process described below. Accordingly, an amount of the binder BND in the surface portion SP may be less than the amount of the binder BND in the deep portion DP. A porosity of the surface portion SP may be greater than the porosity of the deep portion DP. In this case, the surface treatment process may not affect other components such as the negative electrode active material AM and the conductive material. For example, the negative electrode active material AM and/or the conductive material may have a uniform, or substantially uniform, distribution in the negative electrode active material layer AML2.

In the present disclosure, the surface portion SP may refer to a region extending from a surface of the negative electrode active material layer AML2 toward the negative electrode current collector COL2 up to a depth of about 10% to about 30% of a thickness of the negative electrode active material layer AML2. In the present disclosure, the deep portion DP may refer to the remaining region of the negative electrode active material layer AML2 excluding the surface portion SP. The deep portion DP may be a region between the surface portion SP and the negative electrode current collector COL2. The surface portion SP and the deep portion DP may be adjacent to each other in a third direction D3. For example, the surface portion SP may correspond to about 20% of the thickness of the negative electrode active material layer AML2. The deep portion DP may correspond to about 80% of the thickness of the negative electrode active material layer AML2.

According to the example embodiment, an amount of the binder BND in the second region RG2 may be less than the amount of the binder BND in the first region RG1 due to the surface treatment process selectively performed on the second region RG2. A loading level of the second region RG2 may be substantially the same as or different from a loading level of the first region RG1. The difference in the loading level between the first and second regions RG1 and RG2 may be due to a difference in the amount of the binder between the first and the second regions RG1 and RG2. This may be due to the fact that the loading level of the second region RG2 may be reduced compared to the first region RG1 by selectively reducing the binder amount of the second region RG2. However, since the amount of the binder BND reduced by the surface treatment process in the second region RG2 is relatively small, the difference in the loading levels between the first and second regions RG1 and RG2 may be negligible, or the loading levels may be substantially equal.

In the present disclosure, the term “loading level” may refer to a value calculated by dividing the weight of the negative electrode active material layer AML2 (e.g., the negative electrode active material AM, the binder BND, the conductive material, and the like) by the area thereof. The area of the negative electrode active material layer AML2 may be calculated by multiplying the width WI1 in the first direction D1 by the length LE in the second direction D2. The loading level may refer to the loading level on one side of the negative electrode active material layer AML2.

For example, the loading level for each region may be calculated by the following method. First, the negative electrode 20 may be cut along an interface between the first region RG1 and the second region RG2, thereby separating the negative electrode 20 into the first and second regions RG1 and RG2. Thereafter, the loading level may be obtained for each of the resulting first and second regions RG1 and RG2. At this time, the interface between the first and second regions RG1 and RG2 may be visually identified. For example, since the second region RG2 has a relatively dark color and the first region RG1 has a relatively light color, the interface may be defined as a point at which a sharp color change occurs. The loading level of each of the first and second regions RG1 and RG2 may be calculated by Equations 1-2 and 2-2 below.

$$Loading level of the first region RG 1 ( mg / {cm}^{2} ) = \{ Weight of the first region RG 1 / ( Width WI 1 of the first region RG 1 in the first direction D 1 \times Length LE of the first region RG 1 of the second direction D 2 ) \} . \qquad Equation 1 - 2$$

$$Loading level of the second region RG 2 ( mg / {cm}^{2} ) = \{ Weight of the second region RG 2 / ( Width WI 2 of the second region RG 2 in the first direction D 1 \times Length LE of the second region RG 2 of the second direction D 2 ) \} . \qquad Equation 2 - 2$$

Herein, the weight of each of the first and second regions RG1 and RG2 may refer to the weight of the components of the negative electrode active material layer AML2, excluding the negative electrode current collector COL2 from the negative electrode 20.

For example, the loading level of the second region RG2 may be substantially the same as the loading level of the first region RG1. That is, a ratio of the loading level of the second region RG2 to the loading level of the first region RG1 may be about 100%.

As another example, the loading level of the second region RG2 may be less than the loading level of the first region RG1. A ratio of the loading level of the second region RG2 to the loading level of the first region RG1 may be greater than or equal to about 95% and less than about 100%. For example, the ratio of the loading level of the second region RG2 to the loading level of the first region RG1 may be in a range of about 95% to about 99.9%, about 95% to about 99.5%, about 96% to about 99%, or about 97% to about 99%.

When the ratio of the loading level of the second region RG2 to the loading level of the first region RG1 is below the above-described range, asymmetry or imbalance may occur in electrode expansion, adhesion to a negative electrode active material, or electrochemical reactions due to an excessive difference in binder amount between the first and second regions RG1 and RG2. This may lead to deterioration of mechanical properties, cell performance, and thermal stability of the rechargeable lithium battery. When the ratio of the loading level of the second region RG2 to the loading level of the first region RG1 satisfies the above range, enhanced electrolyte impregnation characteristics and lithium deposition reduction or suppression may be achieved. The above-described effects may also be achieved even when the loading levels of the first and second regions RG2 and RG2 are substantially the same.

The loading level of the first region RG1 and the loading level of the second region RG2 may each be in a range of about 5 mg/cm² to about 15 mg/cm². For example, the loading level of each of, or at least one of, the first and second regions RG1 and RG2 may be about 7 mg/cm² to about 15 mg/cm², about 7 mg/cm² to about 12 mg/cm², or about 8 mg/cm² to about 12 mg/cm².

Referring to FIG. 12, FIG. 13A, and FIG. 13B, the first region RG1 may have a first thickness TK1. The second region RG2 may have a second thickness TK2. The second thickness TK2 and the first thickness TK1 may be different from each other. This may be because, the removal of the binder from the surface portion SP of the second region RG2 by the selective surface treatment process causes rearrangement of the particles or an increase in the spacing between the particles, resulting in increased porosity and thickness in the surface portion SP of the second region RG2.

In the present disclosure, the term “thickness” may be measured using a thickness measuring instrument, or determined from images obtained by an optical microscope such as a scanning electron microscope (SEM). The thickness measurement method is not particularly limited as long as the method is known in the art. For example, the thickness of each of the first and second regions RG1 and RG2 may be measured using a micrometer, excluding the thickness of the negative electrode current collector COL2 from the thickness of the negative electrode 20. When the negative electrode active material layer AML2 is non-uniformly formed, the thicknesses of each of the first and second regions RG1 and RG2 may be an average thickness in each region, or the maximum thickness at the thickest location in each region. For example, the thickness of each of the first and second regions RG1 and RG2 may be the average thickness. Herein, the thickness of each region may refer to the thickness measured at a cross-section of the negative electrode active material layer AML2, that is, the thickness of one side thereof.

In an example embodiment, the second thickness TK2 may be greater than the first thickness TK1. A ratio of the second thickness TK2 to the first thickness TK1 may be greater than about 100% and less than or equal to about 120%. For example, the ratio of the second thickness TK2 to the first thickness TK1 may be in a range of about 100.1% to about 117%, about 100.5% to about 115%, about 100.5% to about 110%, or about 100.5% to about 105%.

When the ratio of the second thickness TK2 to the first thickness TK1 is greater than the above-described range, deformation may occur during battery assembly due to thickness imbalance between the first and second regions RG1 and RG2, and cracks may form caused by differences in expansion rate.

The first thickness TK1 may be in a range of about 30 μm to about 100 μm. For example, the first thickness TK1 may be about 35 μm to about 90 μm, about 40 μm to about 90 μm, or about 50 μm to about 80 μm.

The second thickness TK2 may be in a range of about 30 μm to about 110 μm. For example, the second thickness TK2 may be about 35 μm to about 100 μm, about 40 μm to about 90 μm, or about 50 μm to about 90 μm.

According to the example embodiment, a mixture density of the second region RG2 may be less than the mixture density of the first region RG1. This may be due to the fact that the second region RG2 has a greater thickness than the first region RG1. Alternatively, this may be due to the fact that the second region RG2 has a smaller loading level and a greater thickness than the first region RG1.

In the present disclosure, the term “mixture density” may refer to a value calculated by dividing the weight of the negative electrode active material layer AML2 (e.g., the negative electrode active material AM, the binder BND, the conductive material, and the like) of the negative electrode 20, excluding the negative electrode current collector COL2, by the volume thereof. The volume of the negative electrode active material layer AML2 may be calculated by multiplying the area thereof by the thickness thereof. The area of the negative electrode active material layer AML2 may be substantially the same as the area described above. The thickness of the negative electrode active material layer AML2 may refer to the thickness in the third direction D3.

For example, as described above, the mixture density for each region may be obtained by cutting the negative electrode 20 along an interface between the first regions RG1 and the second region RG2 to separate the first regions RG1 from the second region RG2. Thereafter, the mixture density of each of, or at least one of, the resulting first and second regions RG1 and RG2 may be calculated by Equations 3-2 and 4-2 below.

$$Mixture density of the first region RG 1 ( g / cc ) = ( Loading level of the first region RG 1 / Thickness TK 1 of the first region RG 1 ) . \qquad Equation 3 - 2$$

$$Mixture density of the second region RG 2 ( g / cc ) = ( Loading level of the second region RG 2 / Thickness TK 2 of the second region RG 2 ) . \qquad Equation 4 - 2$$

Herein, the loading level of each of the first and second regions RG1 and RG2 may be the same as the loading level described above. The thickness of each of the first and second regions RG1 and RG2 may refer to the average thickness for each region.

A ratio of the mixture density of the second region RG2 to the mixture density of the first region RG1 may be greater than or equal to about 85% and less than about 100%. For example, the ratio of the mixture density of the second region RG2 to the mixture density of the first region RG1 may be in a range of about 85% to about 99.9%, about 90% to about 99.5%, or about 90% to about 99%.

When the ratio of the mixture density of the second region RG2 to the mixture density of the first region RG1 is less than the above-described range, asymmetry or imbalance may occur in electrode expansion, adhesion to the negative electrode active material, or electrochemical reactions due to excessive difference in binder amount or thickness between the first and second regions RG1 and RG2. This may lead to deterioration in mechanical properties, cell performance, and thermal stability of the rechargeable lithium battery. When the ratio of the mixture density of the second region RG2 to the mixture density of the first region RG1 satisfies the above range, the difference in the mixture density between the first and second regions RG1 and RG2 may improve electrolyte impregnation characteristics and reduce or suppress lithium deposition.

The mixture density of the first region RG1 may be in a range of about 1.4 g/cc to about 1.7 g/cc. For example, the mixture density of the first region RG1 may be about 1.45 g/cc to about 1.7 g/cc, or about 1.5 g/cc to about 1.7 g/cc.

The mixture density of the second region RG2 may be in a range of about 1.2 g/cc to about 1.7 g/cc. For example, the mixture density of the second region RG2 may be about 1.25 g/cc to about 1.65 g/cc, about 1.3 g/cc to about 1.6 g/cc, or about 1.4 g/cc to about 1.6 g/cc.

The negative electrode 20 for the rechargeable lithium battery according to an example embodiment of the present disclosure may include the first regions RG1 and the second regions RG2 having different mixture densities. Since the second region RG2 located in the central portion of the negative electrode 20 has a relatively lower mixture density, lithium ion mobility and electrolyte impregnation characteristics may be improved. Accordingly, lithium deposition due to insufficient electrolyte impregnation and deterioration of cell performance may be reduced or suppressed. As a result, a rechargeable lithium battery having a high capacity and improved cycle-life may be provided.

### Method for Manufacturing Negative Electrode

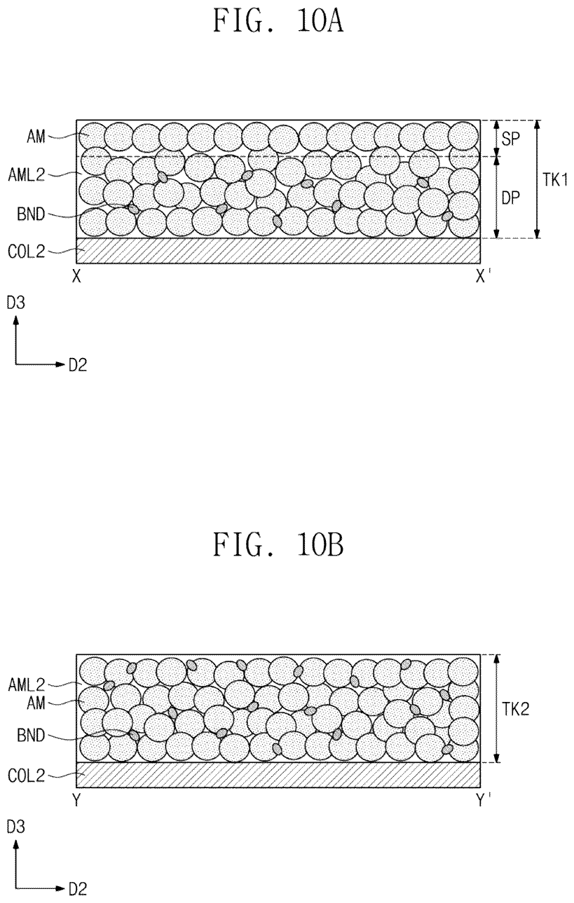

FIG. 11 is a diagram describing a method for manufacturing a negative electrode for a jelly-roll electrode according to an example embodiment of the present disclosure.

A method for manufacturing a negative electrode for a jelly-roll electrode according to an example embodiment of the present disclosure may include preparing a negative electrode current collector COL2, forming a negative electrode active material layer AML2 on the negative electrode current collector COL2, and selectively performing a surface treatment process on a first region RG1, excluding a second region RG2, to remove a binder in a surface portion of the first region RG1.

First, a negative electrode current collector COL2 may be prepared. The negative electrode current collector COL2 may include at least one of a copper foil, a nickel foil, a stainless-steel foil, a titanium foil, a nickel foam, a copper foam, a polymer substrate coated with a conductive metal, or a combination thereof.

The negative electrode active material layer AML2 may be formed on the negative electrode current collector COL2. Forming the negative electrode active material layer AML2 may include applying a negative electrode slurry onto the negative electrode current collector COL2, and then drying the negative electrode slurry.

The negative electrode slurry may include a negative electrode active material, a binder, and an organic solvent. The negative electrode slurry may further include a conductive material as necessary. The negative electrode active material and the binder are added to the organic solvent, and then stirred to prepare the negative electrode slurry.

The organic solvent may be or include a solvent commonly used in the art. For example, the organic solvent may include at least one of dimethyl sulfoxide (DMSO), isopropyl alcohol, N-methylpyrrolidone (NMP), acetone, water, or a combination thereof.

The negative electrode slurry may be applied to at least one surface of the negative electrode current collector COL2 at a constant, or substantially constant, thickness. The application method is not particularly limited, and coating equipment such as, e.g., a doctor blade and a slot die coater may be used.

The negative electrode slurry applied on the negative electrode current collector COL2 may be dried. The solvent included in the negative electrode slurry may be removed through the drying process to form the negative electrode active material layer AML2. Then, a rolling process may be performed on the negative electrode active material layer AML2. In the example embodiment, although the rolling process is performed after the drying process of the negative electrode active material layer AML2, the present disclosure is not limited thereto. In another example embodiment, the rolling process may be omitted during the formation of the negative electrode active material layer AML2, and performed after the surface treatment process.

As described above, the negative electrode active material layer AML2 may have a long axis in one direction (e.g., a first direction D1). The negative electrode active material layer AML2 may include a first region RG1 and a second region RG2 arranged, e.g., sequentially arranged, along the first direction D1.

The first region RG1 may be set to a region to be wound by about 1 turn to about 3 turns from one end of the negative electrode active material layer AML2 when wound in a cylindrical shape. For example, the first region RG1 may be defined as a region extending from one end of the negative electrode active material layer AML2 up to a point corresponding to about 0.5% to about 5% of a length of the long axis. The second region RG2 may be set to a remaining region of the negative electrode active material layer AML2, excluding the first region RG1.

Referring to FIG. 11, the surface treatment process may be selectively performed only on the first region RG1 of the negative electrode active material layer AML2, excluding the second region RG2. The binder in the first region RG1 may be partially removed through the surface treatment process. For example, the binder in a surface portion of the first region RG1 may be removed.

In an example of the present disclosure, the partial removal of the binder in the first region RG1 may indicate that the amount of the binder relative to the total weight of the first region RG1 is reduced to about 50% or less, for example, about 40% or less, about 30% or less, or about 20% or less, compared to before the surface treatment process is performed.

According to an example embodiment of the present disclosure, a mixture density of the first region RG1 may be less than the mixture density of the second region RG2 due to the surface treatment process selectively performed on the first region RG1. This may be due to the fact that as described above, the removal of the binder from the surface portion of the first region RG1 causes rearrangement of the particles or an increase in the spacing between the particles, resulting in increased porosity and thickness in the surface portion of the first regions RG1. Thus, the difference in the mixture density between the first and second regions RG1 and RG2 may be substantially attributed to the difference in thickness between the first and the second regions RG1 and RG2.

A ratio of the mixture density of the first region RG1 to the mixture density of the second region RG2 may be greater than or equal to about 85% and less than about 100%. When the ratio of the mixture density of the first region RG1 to the mixture density of the second region RG2 satisfies the above-described range, lithium ion mobility and electrolyte impregnation characteristics may be improved.

A loading level of the first region RG1 and a loading level of the second region RG2 may be substantially the same, or may be different. For example, the loading level of the first region RG1 may be substantially the same as the loading level of the second region RG2. As another example, the loading level of the first region RG1 may be less than the loading level of the second region RG2.

A thickness of the first region RG1 and a thickness of the second region RG2 may be different from each other. For example, the thickness of the first region RG1 may be greater than the thickness of the second region RG2.

The surface treatment process may be continuously, or substantially continuously, performed by being applied to a process line for manufacturing the negative electrode. The surface treatment process may be performed by any one of a light irradiation, a heat treatment, or a plasma treatment, but is not particularly limited as long as the method is known in the art. For example, the surface treatment process may be performed by light irradiation.

According to an example embodiment of the present disclosure, binder removal through the light irradiation may be performed by selectively thermally decomposing or oxidizing only the binder in the surface portion of the negative electrode active material layer AML2. Since the binder has a relatively lower binding energy and decomposition temperature, it may be possible to selectively remove only the binder through the light irradiation. In this case, other components (e.g., the negative electrode active material and/or the conductive material) may remain unaffected.

The light irradiation may be performed using a light irradiation unit LIU. For example, the light irradiation unit LIU may be or include a xenon flash lamp, but the present disclosure is not limited thereto.

For example, when the light irradiation is performed using the xenon flash lamp, chemical bonds within the binder (e.g., C—C, C═C, or C—H bonds) may be broken due to thermal decomposition or oxidation reactions of the binder. Thus, the binder may be decomposed into low molecular weight volatile compounds and evaporated, or oxidized to CO₂ or moisture and removed.

The light irradiation with a xenon flash lamp may include irradiating light having a broad spectrum of light including infrared rays, visible light, and ultraviolet rays, at high intensity for a short period of time. The light emitted from the xenon flash lamp may have a wavelength range of about 200 nm to about 1500 nm. The light irradiation may include applying a voltage of about 100V to about 1000V. For example, the applied voltage may be about 100V to about 800V, about 200V to about 800V, about 300V to about 700V, or about 300V to about 500V. The light irradiation may be performed for a duration in a range of about 100 μs to about 2000 μs. For example, the irradiation time may be about 100 μs to about 1500 μs, about 100 μs to about 1000 μs, about 100 μs to about 500 μs, or about 100 μs to about 400 μs. When the light irradiation is performed under conditions in which the applied voltage and the irradiation time each exceed the above range, an excessive reduction in the loading level caused by electrode delamination may lead to manufacturing issues. When the light irradiation is performed under the above conditions, the binder in the light irradiation region (e.g., the first region RG1) may be removed in a desired amount. Therefore, the applied voltage and the irradiation time may be adjusted as desired in consideration of various factors such as, e.g., electrode delamination, mechanical strength, or side reactions with the electrolyte.

The method for manufacturing the negative electrode according to an example embodiment of the present disclosure may further include a post-treatment process after the surface treatment process. The post-treatment process may include, e.g., removing carbonized residues generated during the thermal decomposition or oxidation of the binder by the light irradiation. For example, the post-treatment process may be performed by chemical cleaning, physical cleaning, or laser cleaning.

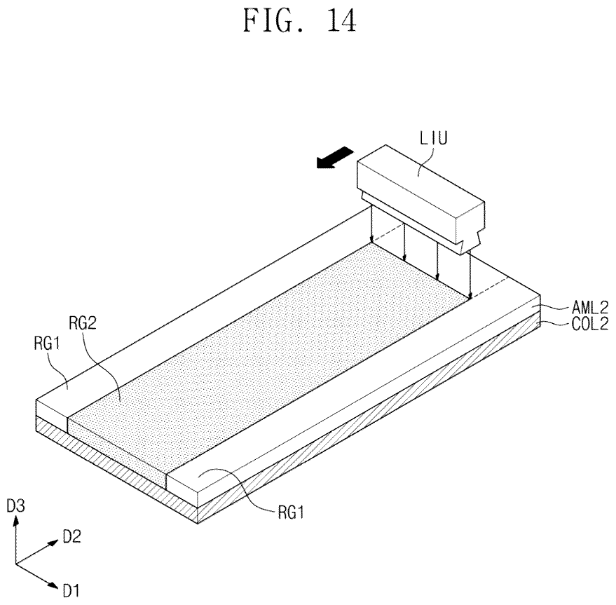

FIG. 14 is a diagram describing a method for manufacturing a negative electrode for a rechargeable lithium battery according to another example embodiment of the present disclosure. Hereinafter, a detailed description of technical features that overlap with the technical features described above with reference to FIG. 11 are omitted, and differences are described in detail below.

A method for manufacturing a negative electrode for a rechargeable lithium battery according to another example embodiment of the present disclosure may include preparing a negative electrode current collector COL2, forming a negative electrode active material layer AML2 on the negative electrode current collector COL2, and selectively performing a surface treatment process on a second region RG2 excluding first regions RG1 to remove a binder in a surface portion of the second region RG2.

As described above, the negative electrode active material layer AML2 may have a short axis in one direction (a first direction D1). The negative electrode active material layer AML2 may include first regions RG1 opposing each other in the first direction D1, and a second region RG2 between the first regions RG2.

The second region RG2 may be set to a region having a predetermined or desired width. The predetermined or desired width may be in a range of about 40% to about 80% of the short axis length of the negative electrode active material layer AML2. The first region RG1 may be set to a region provided on both sides of the second region RG2 in the first direction D1.

Referring to FIG. 14, the surface treatment process may be selectively performed only on the second region RG2 of the negative electrode active material layer AML2 excluding the first region RG1. The binder in the second region RG2 may be partially removed through the surface treatment process. For example, the binder in a surface portion of the second region RG2 may be removed.

In an example of the present disclosure, the partial removal of the binder in the second region RG2 may indicate that the amount of the binder relative to the total weight of the second region RG2 is reduced to about 50% or less, for example, about 40% or less, about 30% or less, or about 20% or less, compared to before the surface treatment process is performed.

According to the example embodiment, a mixture density of the second region RG2 may be less than the mixture density of the first region RG1 due to the surface treatment process selectively performed on the second region RG2. This may be due to the fact that, as described above, the removal of the binder from the surface portion of the second region RG2 causes rearrangement of the particles or an increase in the spacing between the particles, resulting in increased porosity and thickness in the surface portion of the second regions RG2. Thus, the difference in the mixture density between the first and second regions RG1 and RG2 may be substantially attributed to the difference in the thickness between the first and second regions RG1 and RG2.

A ratio of the mixture density of the second region RG2 to the mixture density of the first region RG1 may be greater than or equal to about 85% and less than about 100%. When the ratio of the mixture density of the second region RG2 to the mixture density of the first region RG1 satisfies the above-described range, lithium ion mobility and electrolyte impregnation characteristics may be improved.

A loading level of the first region RG1 and the loading level of the second region RG2 may be substantially the same, or different. For example, the loading level of the second region RG2 may be substantially the same as the loading level of the first region RG1. As another example, the loading level of the second region RG2 may be less than the loading level of the first region RG1.

A thickness of the first region RG1 and a thickness of the second region RG2 may be different from each other. For example, the thickness of the second region RG2 may be greater than the thickness of the first region RG1.

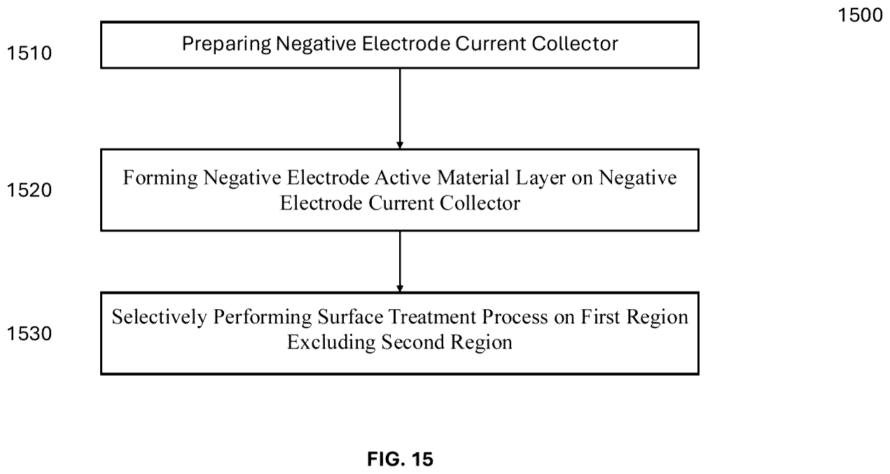

FIG. 15 is a flowchart illustrating a method of manufacturing a negative electrode, according to an example embodiment. In FIG. 15, the method 1500 includes operation 1510 which includes preparing a negative electrode current collector. Operation 1520 includes forming a negative electrode active material layer on the negative electrode current collector, the negative electrode active material layer having a long axis extending in a first direction, the negative electrode active material layer including a first region and a second region arranged, e.g., sequentially arranged, along the first direction. In an example, a mixture density of the first region is less than a mixture density of the second region. For example, the first region is defined as a region extending from one end of the negative electrode active material layer to a point corresponding to about 0.5% to about 5% of a length of the long axis, the second region is a remaining region of the negative electrode active material layer excluding the first region, and a ratio of the mixture density of the first region to the mixture density of the second region is greater than or equal to about 85% and less than about 100%. In yet another example, a thickness of the first region is greater than a thickness of the second region.

Operation 1530 includes selectively performing a surface treatment process on the first region excluding the second region to remove a binder in a surface portion of the first region. In an example, a thickness of the first region is greater than a thickness of the second region. In another example, the surface treatment process is performed by a light irradiation using a flash lamp, the light irradiation includes applying a voltage in a range of about 100 V to about 1000 V, and the light irradiation is performed for a duration in a range of about 100 us to about 2000 μs.

Hereinafter, examples of the present disclosure are described in more detail as follows. However, these examples shown below are provided to assist understanding of the present disclosure, and the scope of the present disclosure is not limited to these examples.

### Example 1-1

### Manufacture of Negative Electrode:

A negative electrode slurry was prepared by mixing 98 wt % of artificial graphite, 0.5 wt % of carboxymethyl cellulose, and 1.5 wt % of styrene-butadiene rubber in pure water.

The prepared negative electrode slurry was applied onto both sides of a copper current collector having a thickness of about 8 μm, and then the slurry was dried and rolled to form a negative electrode active material layer. A thickness of one side of the negative electrode active material layer was about 72 μm, a loading level on one side was about 11.5 mg/cm², and a mixture density was about 1.6 g/cc.

In the negative electrode active material layer, a first region is defined as a region extending from one end (the winding leading end A) of the negative electrode active material layer to a point corresponding to about 3% of the width (W1) in the first direction (D1) of the negative electrode active material layer (e.g., a region wound for 2 turns from the winding leading end, when wound in a cylindrical shape). The remaining region of the negative electrode active material layer, excluding the first region, is defined as a second region (see FIG. 9).

A light irradiation process was selectively performed on the first region of the negative electrode active material layer. The light irradiation process was performed using a Xenon Flash Lamp (Pulseforge Inc.) under the following conditions. As a result, the mixture density of the first region was reduced, while that of the second region was maintained.
Irradiation time: 350 μs.
Applied voltage: 400 V.

### Manufacture of Cylindrical Rechargeable Lithium Battery:

A positive electrode slurry was prepared by mixing 98.5 wt % of LiCoO₂, 1 wt % of polyvinylidenefluoride (PVdF), and 0.5 wt % of carbon black in N-methylpyrrolidone.

The prepared positive electrode slurry was applied onto an Al current collector having a thickness of about 10 μm, and then the slurry was dried and rolled to form a positive electrode active material layer having a total thickness of about 90 μm.

The negative electrode, the positive electrode, and a polyethylene separator having a thickness of about 10 μm were stacked to prepare an electrode assembly. The electrode assembly was wound into a cylindrical shape and placed in a case, and then an electrolyte was injected to manufacture a cylindrical rechargeable lithium battery.

As the electrolyte, one in which 1.3 M LiPF₆ was dissolved in a mixed organic solvent of ethylene carbonate (EC), ethyl methyl carbonate (EMC), and diethyl carbonate (DEC) (3:5:2 by volume ratio) was used.

### Example 1-2

A negative electrode was manufactured in the same manner as in Example 1-1, with a difference that the applied voltage was changed to 500 V under the above light irradiation conditions.

A cylindrical rechargeable lithium battery was manufactured in the same manner as in Example 1-1, with a difference that the negative electrode was used.

### Examples 1-3

A negative electrode was manufactured in the same manner as in Example 1-1, with a difference that the applied voltage was changed to 600 V under the above light irradiation conditions.

A cylindrical rechargeable lithium battery was manufactured in the same manner as in Example 1-1, with a difference that the negative electrode was used.

### Examples 1-4

A negative electrode was manufactured in the same manner as in Example 1-1, with a difference that the irradiation time was changed to 500 μs and the applied voltage was changed to 700 V under the above light irradiation conditions.

A cylindrical rechargeable lithium battery was manufactured in the same manner as in Example 1-1, with a difference that the negative electrode was used.

### Comparative Example 1-1

A negative electrode was manufactured in the same manner as in Example 1-1, with a difference that the light irradiation process was omitted.

A cylindrical rechargeable lithium battery was manufactured in the same manner as in Example 1-1, with a difference that the negative electrode was used.

### Example 2-1

### Manufacture of Negative Electrode:

A negative electrode slurry was prepared by mixing 98 wt % of artificial graphite, 0.5 wt % of carboxymethyl cellulose, and 1.5 wt % of styrene-butadiene rubber in pure water.

The prepared negative electrode slurry was applied onto both sides of copper current collector having a thickness of about 8 μm, and then the slurry was dried and rolled to form a negative electrode active material layer. A thickness of one side of the negative electrode active material layer was about 72 μm, a loading level on one side was about 11.5 mg/cm², and a mixture density was about 1.6 g/cc.

In the negative electrode active material layer, a second region is defined as a region corresponding to about 60% of the width W1 in the first direction D1 of the negative electrode active material layer, located in the central portion of the negative electrode. First regions are defined as regions provided on both sides of the second region and located in the edge portions of the negative electrode (see FIG. 12).

A light irradiation process was selectively performed on the second region of the negative electrode active material layer. The light irradiation process was performed using a Xenon Flash Lamp (Pulseforge Inc.) under the following conditions. As a result, the mixture density of the second region was reduced, while the mixture density of the first region was maintained.
Irradiation time: 350 μs.
Applied voltage: 400 V.

### Manufacture of Half-Cell:

A half-cell was manufactured by a conventional method using the negative electrode, a lithium metal counter electrode, and an electrolyte. As the electrolyte, one in which 1.3 M LiPF₆ was dissolved in a mixed organic solvent of ethylene carbonate (EC), ethyl methyl carbonate (EMC), and diethyl carbonate (DEC) (3:5:2 by volume ratio) was used.

### Manufacture of Rechargeable Lithium Battery:

A positive electrode slurry was prepared by mixing 98.5 wt % of LiCoO₂, 1 wt % of polyvinylidenefluoride (PVdF), and 0.5 wt % of carbon black in N-methylpyrrolidone.

The prepared positive electrode slurry was applied onto an Al current collector having a thickness of about 10 μm, and then the slurry was dried and rolled to form a positive electrode active material layer having a total thickness of about 90 μm.

### Manufacture of Rechargeable Lithium Battery:

The negative electrode, the positive electrode, and a polyethylene separator having a thickness of about 10 μm were stacked to prepare an electrode assembly. The electrode assembly was placed in a case, and then the electrolyte was injected to manufacture a rechargeable lithium battery.

### Example 2-2

A negative electrode was manufactured in the same manner as in Example 2-1, with a difference that the applied voltage was changed to 500 V under the above light irradiation conditions.

A half-cell and a rechargeable lithium battery were manufactured in the same manner as in Example 2-1, with a difference that the negative electrode was used.

### Example 2-3

A negative electrode was manufactured in the same manner as in Example 2-1, with a difference that the applied voltage was changed to 600 V under the above light irradiation conditions.

A half-cell and a rechargeable lithium battery were manufactured in the same manner as in Example 2-1, with a difference that the negative electrode was used.

### Example 2-4

A negative electrode was manufactured in the same manner as in Example 2-1, with a difference that the irradiation time was changed to 500 μs and the applied voltage was changed to 700 V under the above light irradiation conditions.

A half-cell and a rechargeable lithium battery were manufactured in the same manner as in Example 2-1, with a difference that the negative electrode was used.

### Comparative Example 2-1

A negative electrode was manufactured in the same manner as in Example 2-1, with a difference that the light irradiation process was omitted.

A half-cell and a rechargeable lithium battery were manufactured in the same manner as in Example 2-1, with a difference that the negative electrode was used.

### Evaluation Example 1-1: Measurement of Mixture Density, Loading Level, and Thickness

The negative electrodes manufactured according to Examples 1-1 to 1-4 and Comparative Example 1-1 were cut by punching each region with a circular electrode plate having a diameter of 14 mm using a circular punching machine (Wellcos Corporation, WCH-125), and then the mixture density, the loading level, and the thickness of the negative electrode active material layer were measured and shown in Table 1 below.

### 1) Mixture Density

The mixture density was calculated by measuring the weight and the volume (area× thickness) of the circular electrode plate excluding the negative electrode current collector (i.e., the negative electrode active material layer), and then dividing the weight of the negative electrode active material layer by the volume thereof.

### 2) Loading Level

The loading level was calculated by measuring the weight and the area of the circular electrode plate excluding the negative electrode current collector (i.e., the negative electrode active material layer), and then dividing the weight of the negative electrode active material layer by the area thereof.

### 3) Thickness

The average thickness of the negative electrode active material layer, excluding the negative electrode current collector, was measured from the circular electrode plate using a thickness meter (micrometer).

TABLE 1

| | Mixture Density | | | Loading Level | | | Thickness | | |
|---|---|---|---|---|---|---|---|---|---|
| | (g/cc) | | | (mg/cm², one side) | | | (μm, one side) | | |
| | First | Second | Ratio | First | Second | Ratio | First | Second | Ratio |
| | Region | Region | (%) | Region | Region | (%) | Region | Region | (%) |
| Example 1-1 | 1.59 | 1.60 | 99.4 | 11.5 | 11.5 | 100 | 72.5 | 72 | 100.7 |
| Example 1-2 | 1.58 | 1.60 | 98.8 | 11.5 | 11.5 | 100 | 73 | 72 | 101.4 |
| Example 1-3 | 1.55 | 1.60 | 96.9 | 11.5 | 11.5 | 100 | 74.5 | 72 | 103.5 |
| Example 1-4 | 1.41 | 1.60 | 88.1 | 11.2 | 11.5 | 97.4 | 82.9 | 72 | 115.1 |
| Comparative | 1.60 | | 100 | 11.5 | | 100 | 72 | | 100 |
| Example 1-1 | | | | | | | | | |

### Evaluation Example 1-2: Evaluation of Electrolyte Impregnation Characteristics

Electrolyte impregnation characteristics of the negative electrodes manufactured according to Examples 1-1 to 1-4 and Comparative Example 1-1 were evaluated by the following method. A predetermined area including the first region, which corresponds to the winding center portion, was sampled with a size of about 7 cm×10 cm. The evaluation was performed by dropping about 1 μl of the electrolyte onto the sample using a pipette, and measuring the time until the contact angle reached about 0°. The results are shown as electrolyte impregnation time in Table 2 below.

### Evaluation Example 1-3: Evaluation of Cycle-Life Characteristics

The rechargeable lithium batteries manufactured according to Examples 1-1 to 1-4 and Comparative Example 1-1 were charged at room temperature (25° C.) under constant current/constant voltage (CC/CV) conditions of 1.0 C, 4.25 V, and 0.05 C cut-off, followed by a 10-minute rest. The batteries were then discharged under a constant current condition of 1.0 C, with a 2.8 V cut-off, followed by another 10-minute rest. This procedure was defined as one cycle, and the charge/discharge cycling was repeatedly performed under the same conditions. At this time, the number of cycles until the capacity retention rate reached 80% was measured, and the results are shown as cycle-life characteristics in Table 2 below. The capacity retention rate was calculated according to Equation 5 below.

$$Capacity retention rate ( \% ) = ( discharge capacity at each cycle / discharge capacity at {1}^{st} cycle ) \times 100. \qquad Equation 5$$

### Evaluation Example 1-4: Evaluation of Lithium Deposition Amount

The rechargeable lithium batteries manufactured according to Examples 1-1 to 1-4 and Comparative Example 1-1 were charged and discharged 500 times at 0.1 C. Thereafter, the batteries were disassembled, and the negative electrodes were separated to evaluate the amount of lithium deposition on the surface of the negative electrodes by measuring the area of deposited lithium. The area of deposited lithium was measured via image processing using the image J program, in which the area of the region where lithium deposition occurred on the negative electrode surface was calculated. The amount of lithium deposition was calculated by Equation 6 below, and the results are shown in Table 2 below.

$$Lithium Deposition Amount ( \% ) = ( deposited lithium area / negative electrode active material area ) \times 100. \qquad Equation 6$$

TABLE 2

| | Electrolyte | Lithium | Cycle-Life |
|---|---|---|---|
| | Impregnation | Deposition | Characteristics |
| | Time (s) | Amount (%) | (Cycle@SOH 80%) |
| Example 1-1 | 204 | 15 | 260 |
| Example 1-2 | 175 | 7 | 290 |
| Examples 1-3 | 117 | 2 | 350 |
| Examples 1-4 | 97 | 2 | 360 |
| Comparative | 220 | 19 | 250 |
| Example 1-1 | | | |

Referring to Table 2, it can be confirmed that Examples 1-1 to 1-4 exhibit enhanced electrolyte impregnation characteristics and lithium deposition suppression effect compared to Comparative Example 1-1. In addition, it can be seen that Examples 1-1 to 1-4 exhibit improved cycle-life characteristics compared to Comparative Example 1-1.

### Evaluation Example 2-1: Measurement of Mixture Density, Loading Level, and Thickness

The negative electrodes manufactured according to Examples 2-1 to 2-4 and Comparative Example 2-1 were cut by punching each region with a circular electrode plate having a diameter of 14 mm using a circular punching machine (Wellcos Corporation, WCH-125), and then the mixture density, the loading level, and the thickness of the negative electrode active material layer were measured, and are shown in Table 3 below.

### 1) Mixture Density

The mixture density was calculated by measuring the weight and the volume (area× thickness) of the circular electrode plate excluding the negative electrode current collector (i.e., the negative electrode active material layer), and then dividing the weight of the negative electrode active material layer by volume thereof.

### 2) Loading Level

The loading level was calculated by measuring the weight and the area of the circular electrode plate excluding the negative electrode current collector (i.e., the negative electrode active material layer), and then dividing the weight of the negative electrode active material layer by the area thereof.

### 3) Thickness

The average thickness of the negative electrode active material layer, excluding the negative electrode current collector, was measured from the circular electrode plate using a thickness meter (micrometer).

TABLE 3

| | Mixture Density | | | Loading Level | | | Thickness | | |
|---|---|---|---|---|---|---|---|---|---|
| | (g/cc) | | | (mg/cm², one side) | | | (μm, one side) | | |
| | First | Second | Ratio | First | Second | Ratio | First | Second | Ratio |
| | Region | Region | (%) | Region | Region | (%) | Region | Region | (%) |
| Example 2-1 | 1.60 | 1.59 | 99.4 | 11.5 | 11.5 | 100 | 72 | 72.5 | 100.7 |
| Example 2-2 | 1.60 | 1.58 | 98.8 | 11.5 | 11.5 | 100 | 72 | 73 | 101.4 |
| Example 2-3 | 1.60 | 1.55 | 96.9 | 11.5 | 11.5 | 100 | 72 | 74.5 | 103.5 |
| Example 2-4 | 1.60 | 1.41 | 88.1 | 11.5 | 11.2 | 97.4 | 72 | 82 | 113.9 |
| Comparative | 1.60 | | 100 | 11.5 | | 100 | 72 | | 100 |
| Example | | | | | | | | | |
| 2-1 | | | | | | | | | |

### Evaluation Example 2-2: Evaluation of Electrolyte Impregnation Characteristics

Electrolyte impregnation characteristics of the negative electrodes manufactured according to Examples 2-1 to 2-4 and Comparative Example 2-1 were evaluated by the following method. A predetermined area including the second region, which corresponds to the central portion of the negative electrode, was sampled with a size of about 7 cm×10 cm. The evaluation was performed by dropping about 1 μl of the electrolyte onto the sample surface using a pipette, and measuring the time until the contact angle reached about 0°. The results are shown as electrolyte impregnation time in Table 4 below.

### Evaluation Example 2-3: Evaluation of Lithium Deposition Amount

The half cells manufactured according to Examples 2-1 to 2-4 and Comparative Example 2-1 were subjected to a formation process by performing two charge/discharge cycles at room temperature (25° C.) under the following conditions: constant current/constant voltage (CC/CV) charging at 0.1 C, 0.01 V, and a cut-off current of 0.025 C, followed by a 10-minute rest, then constant current discharging at 0.1 C, with a cut-off voltage of 1.5 V, followed by another 10-minute rest. This procedure was defined as one cycle, and this cycle was repeated twice under the same conditions to complete the formation process.

After the formation process, the half-cells in the resting state were discharged at a constant current of 0.1 C until reaching 1.5 V, followed by constant current charging at 2.0 C, 1.0 V cut-off voltage or 30 min cut-off time. Subsequently, without a rest time, the cells were discharged again at a constant current of 0.1 C.

The dV/dQ profile was analyzed during the 0.1 C constant current discharging process immediately after the 2.0 C constant current charging process, and a peak signal of lithium stripping from the deposited lithium was confirmed. The amount of lithium deposition (mAh/g) was calculated from the dV/dQ peak due to the lithium stripping reaction. The results are shown in Table 4 below.

### Evaluation Example 2-4: Evaluation of Cycle-Life Characteristics

The rechargeable lithium batteries manufactured according to Examples 2-1 to 2-4 and Comparative Example 2-1 were charged at room temperature (25° C.) under constant current/constant voltage (CC/CV) conditions of 0.5 C, 4.25 V, and 0.05 C cut-off, followed by a 10-minute rest. The batteries were then discharged under constant current (CC) conditions of 0.5 C with a cut-off voltage of 2.8 V, followed by another 10-minute rest. This procedure was defined as one cycle, and the charge/discharge cycling was repeatedly performed under the same conditions. At this time, the number of cycles until the capacity retention rate reached 80% was measured, and the results are shown as cycle-life characteristics in Table 4 below. The capacity retention rate was calculated according to the above Equation 5.

TABLE 4

| | Electrolyte | Lithium | Cycle-Life |
|---|---|---|---|
| | Impregnation | Deposition | Characteristics |
| | Time (s) | Amount (mAh/g) | (Cycle@SOH 80%) |
| Example 2-1 | 204 | 41 | 762 |
| Example 2-2 | 175 | 39 | 798 |
| Example 2-3 | 117 | 35 | 817 |
| Example 2-4 | 97 | 28 | 800 |
| Comparative | 220 | 42 | 746 |
| Example 2-1 | | | |

Referring to Table 4 above, it can be confirmed that Examples 2-1 to 2-4 exhibit improved electrolyte impregnation characteristics and lithium deposition suppression effect, compared to Comparative Example 2-1. In addition, it can be seen that, Examples 2-1 to 2-4 exhibit enhanced cycle-life characteristics compared to Comparative Example 2-1.

The negative electrode for the jelly-roll electrode according to an example embodiment of the present disclosure, may have a relatively low mixture density in the first region where winding begins. This allows the electrolyte to penetrate more effectively into the first region, thereby reducing or preventing lithium deposition that may occur during charging and discharging of the battery and the resulting deterioration in cell performance. As a result, the rechargeable lithium battery including the negative electrode of the present disclosure may have improved cycle-life characteristics.

The negative electrode for the rechargeable lithium battery according to another example embodiment of the present disclosure may have a relatively low mixture density in the second region located in the central portion of the negative electrode. This allows the electrolyte to penetrate more effectively into the second region, thereby reducing or preventing lithium deposition that may occur during charging and discharging of the battery and the resulting deterioration in cell performance. As a result, the rechargeable lithium battery including the negative electrode according to the present disclosure may have improved cycle-life characteristics.

The method for manufacturing the negative electrode for the jelly-roll electrode according to an example embodiment of the present disclosure may include performing a surface treatment on the first region where winding begins, thereby reducing the mixture density of the first region. As a result, the negative electrode having improved electrolyte impregnation characteristics may be manufactured.

The method for manufacturing the negative electrode for the rechargeable lithium battery according to another example embodiment of the present disclosure may include performing a surface treatment on the second region located in the central portion of the negative electrode, thereby reducing the mixture density of the second region. As a result, the negative electrode having improved electrolyte impregnation characteristics may be manufactured.

While the present disclosure has been described with reference to example embodiments, it should be understood that these example embodiments are provided for illustrative purposes only and do not limit the scope of the present disclosure. Various modifications and equivalent arrangements may be made without departing from the spirit and scope of the appended claims. Accordingly, the described embodiments should be regarded as examples rather than limitations of the present disclosure.

What is claimed is:

1. A negative electrode for a jelly-roll electrode, the negative electrode comprising:
a negative electrode current collector; and
a negative electrode active material layer on the negative electrode current collector,
wherein the negative electrode active material layer has a long axis extending in a first direction,
wherein the negative electrode active material layer comprises a first region and a second region arranged along the first direction, and
wherein a ratio of a mixture density of the first region to a mixture density of the second region is greater than or equal to about 85% and less than about 100%.

2. The negative electrode as claimed in claim 1, wherein the first region extends from one end of the negative electrode active material layer to a point corresponding to about 0.5% to about 5% of a length of the long axis, and
wherein the second region is a remaining region of the negative electrode active material layer excluding the first region.

3. The negative electrode as claimed in claim 1, wherein an amount of a binder in a surface portion of the first region is less than the amount of the binder in a deep portion of the first region, and
wherein a porosity of the surface portion of the first region is greater than the porosity of the deep portion of the first region.

4. The negative electrode as claimed in claim 1, wherein an amount of a binder in the first region is less than the amount of the binder in the second region,
wherein the mixture density of the first region is in a range of about 1.2 g/cc to about 1.7 g/cc, and
wherein the mixture density of the second region is in a range of about 1.4 g/cc to about 1.7 g/cc.

5. The negative electrode as claimed in claim 1, wherein a loading level of the first region and a loading level of the second region are the same.

6. The negative electrode as claimed in claim 5, wherein the loading level of the first region is in a range of about 5 mg/cm² to about 15 mg/cm², and
wherein the loading level of the second region is in a range of about 5 mg/cm² to about 15 mg/cm².

7. The negative electrode as claimed in claim 1, wherein a thickness of the first region is greater than a thickness of the second region.

8. The negative electrode as claimed in claim 7, wherein a ratio of the thickness of the first region to the thickness of the second region is greater than 100% and less than or equal to about 120%,
wherein the thickness of the first region is in a range of about 50 μm to about 125 μm, and
wherein the thickness of the second region is in a range of about 50 μm to about 110 μm.

9. A negative electrode for a rechargeable lithium battery, the negative electrode comprising:
a negative electrode current collector; and
a negative electrode active material layer on the negative electrode current collector,
wherein the negative electrode active material layer has a short axis extending in a first direction,
wherein the negative electrode active material layer comprises:
first regions opposing each other in the first direction; and
a second region between the first regions, and
wherein a ratio of a mixture density of the second region to a mixture density of the first regions is greater than or equal to about 85% and less than about 100%.

10. The negative electrode as claimed in claim 9, wherein a width of the second region in the first direction is in a range of about 40% to about 80% of a length of the short axis of the negative electrode active material layer.

11. The negative electrode as claimed in claim 9, wherein an amount of a binder in a surface portion of the second region is less than an amount of the binder in a deep portion of the second region, and
wherein a porosity of the surface portion of the second region is greater than a porosity of the deep portion of the second region.

12. The negative electrode as claimed in claim 9, wherein an amount of the binder in the second region is less than an amount of the binder in the first region,
wherein the mixture density of the first region is in a range of about 1.4 g/cc to about 1.7 g/cc, and
wherein the mixture density of the second region is in a range of about 1.2 g/cc to about 1.7 g/cc.

13. The negative electrode as claimed in claim 9, wherein a loading level of the first region and a loading level of the second region are the same.

14. The negative electrode as claimed in claim 13, wherein the loading level of the first region is in a range of about 5 mg/cm² to about 15 mg/cm², and
wherein the loading level of the second region is in a range of about 5 mg/cm² to about 15 mg/cm².

15. The negative electrode as claimed in claim 9, wherein a thickness of the second region is greater than a thickness of the first region.

16. The negative electrode as claimed in claim 15, wherein a ratio of the thickness of the second region to a thickness of the first region is more than about 100% and less than or equal to about 120%,
wherein the thickness of the first region is in a range of about 30 μm to about 100 μm, and
wherein the thickness of the second region is in a range of about 30 μm to about 110 μm.

17. A method for manufacturing a negative electrode, the method comprising:
preparing a negative electrode current collector;
forming a negative electrode active material layer on the negative electrode current collector, the negative electrode active material layer having a long axis extending in a first direction, the negative electrode active material layer comprising a first region and a second region arranged along the first direction; and
selectively performing a surface treatment process on the first region excluding the second region to remove a binder in a surface portion of the first region,
wherein a mixture density of the first region is less than a mixture density of the second region.

18. The method as claimed in claim 17, wherein the first region is defined as a region extending from one end of the negative electrode active material layer to a point corresponding to about 0.5% to about 5% of a length of the long axis,
wherein the second region is a remaining region of the negative electrode active material layer excluding the first region, and
a ratio of the mixture density of the first region to the mixture density of the second region is greater than or equal to about 85% and less than about 100%.

19. The method as claimed in claim 17, wherein a thickness of the first region is greater than a thickness of the second region.

20. The method as claimed in claim 17, wherein the surface treatment process is performed by a light irradiation using a flash lamp,
wherein the light irradiation comprises applying a voltage in a range of about 100 V to about 1000 V, and
wherein the light irradiation is performed for a duration in a range of about 100 μs to about 2000 μs.
